(19) United States
(12) Patent Application Publication
(10) Pub. No.: US 2013/0127809 A1
(43) Pub. Date: May 23, 2013

(54) SCAN DRIVER, DISPLAY DEVICE COMPRISING THE SAME, AND DRIVING METHOD OF SCAN DRIVER

(71) Applicant: Sang-Myeon HAN, Yongin-City (KR)

(72) Inventor: Sang-Myeon HAN, Yongin-City (KR)

(21) Appl. No.: 13/479,517

(22) Filed: May 24, 2012

(30) Foreign Application Priority Data
Nov. 18, 2011 (KR) 10-2011-0121123

(51) Int. Cl. G09G 5/00

(52) U.S. Cl. 345/211; 345/204

(57) ABSTRACT

A scan driver, a display device including the same, and a driving method of a scan driver are provided. The scan driver includes a signal generator configured to generate and output first signals to output lines sequentially and/or to generate and output second signals to the output lines simultaneously, and a switching unit configured to receive the first signals and/or the second signals from the signal generator and to select a plurality of first scan lines connected to a first group pixels among the plurality of pixels included in a display unit or a plurality of second scan lines connected to a second group pixel different from the first group pixels among the plurality of pixels to output the plurality of first signals or the plurality of second signals as corresponding scan signals.

### CROSS-REFERENCE TO RELATED APPLICATION

This application claims priority to and the benefit of Korean Patent Application No. 10-2011-0121123 filed in the Korean Intellectual Property Office on Nov. 18, 2011, the entire contents of which are incorporated herein by reference.

### BACKGROUND

1. Field

Embodiments relate to a scan driver, a display device including the same, and a driving method of a scan driver, and more particularly, to a scan driver applied to a large or high-resolution display device and a driving technique thereof.

2. Description of the Related Art

Recently, stereoscopic image display devices stereoscopically recognizing an image displayed by using a flat display panel and driving techniques thereof have been developed in various manners.

Further, while 3D stereoscopic image displays may be only a fad, display size and/or improved display quality will remain sought after features. For example, larger sized display panels and/or displays having improved image quality and clarity are required. Further, flat panel display devices having improved image quality and clarity, and being capable of displaying 3D motion pictures and an embedded circuit included therein are being developed.

Since a driving circuit embedded in the display device may be complicated and have a large area according to an implementing manner of the stereoscopic image, even though the driving circuit performs the same function in the display device, a structure thereof should be designed so as to be simplified and to occupy a relatively small or smaller area in the display device. Accordingly, research is required so that an outer portion of a slim panel of the display device can be designed as a whole by applying the embedded circuit integrated in the small size to the display device.

The above information disclosed in this Background section is only for enhancement of understanding of the background of the invention and therefore it may contain information that does not form the prior art that is already known in this country to a person of ordinary skill in the art.

### SUMMARY

One or more embodiments provide a scan driver configured to have a small area in a display device while a circuit design is relatively simplified and a display device including the same in a scan driver applied and driven in a large-sized or high-resolution display device.

One or more embodiments provide a method of implementing an operation of a new scan driver capable of reducing an outer area of an entire display device by reducing a number of constituent elements and an area occupied in the display.

One or more embodiments provide a scan driver capable of reducing an outer area of the entire display device by reducing the number of constituent elements and an area occupied in the display device and a display device including the same.

One or more embodiments provide a driving method of implementing an operation of a can driver applied and driven in a large-sized or high-resolution display device.

One or more embodiments provide a scan driver, including a signal generator generating and outputting a plurality of first signals to a plurality of output lines in sequence or generating and outputting a plurality of second signals to the plurality of output lines at the same time; and a switching unit receiving the plurality of first signals or the plurality of second signals from the signal generator and selecting a plurality of first scan lines connected to a first group pixel among the plurality of pixels included in a display unit or a plurality of second scan lines connected to a second group pixel different from the first group pixel among the plurality of pixels to output the plurality of first signals or the plurality of second signals as corresponding scan signals.

One or more embodiments provide a display device, including a display unit including a first group pixel configured by a plurality of pixels and a second group pixel different from the first group pixel and configured by a plurality of pixels; a data driver transferring data signals to a plurality of data lines connected to the display unit; and a scan driver transferring scan signals to a plurality of first scan lines connected to the first group pixel or a plurality of second scan lines connected to the second group pixel so that the data signals are transferred to the display unit, in which the scan driver includes a signal generator and a switching unit connected with each other through the plurality of output lines.

The signal generator may generate and output a plurality of first signals to the plurality of output lines in sequence or generate and output a plurality of second signals at the same time and the switching unit may receive the plurality of first signals or the plurality of second signals to select the plurality of first scan lines or the plurality of second scan lines to output the plurality of first signals or the plurality of second signals as the scan signals.

One or more embodiments provide a driving method of a scan driver, including a signal generator and a switching unit connected with each other through a plurality of output lines and transferring scan signals to a plurality of first scan lines connected to a first group pixel configured by a plurality of pixels or a plurality of second scan lines connected to a second group pixel different from the first group pixel and configured by a plurality of pixels, the driving method including generating and outputting a plurality of first signals to a plurality of output lines in sequence or generating and outputting a plurality of second signals at the same time by the signal generator; receiving a first selection signal selecting the plurality of first scan lines or a second selection signal selecting the plurality of second scan lines by the switching unit; and outputting the plurality of first signals or the plurality of second signals as the scan signals by selecting the plurality of first scan lines or the plurality of second scan lines according to the first selection signal or the second selection signal.

### BRIEF DESCRIPTION OF THE DRAWINGS

FIG. 1 illustrates a schematic diagram of a driving mode of a display device including a scan driver according to an exemplary embodiment;

FIG. 2 illustrates a block diagram of a display device including a scan driver according to an exemplary embodiment;

FIG. 3 illustrates a schematic diagram of a driving of a scan driver in the related art included in a display device;

FIG. 4 illustrates a schematic diagram of a configuration of a scan driver and a driving method thereof according to an exemplary embodiment;

FIG. 5 illustrates a block diagram of a configuration of a signal generation group in the scan driver of FIG. 4;

FIG. 6 illustrates a block diagram of a configuration of a first driver in the signal generation group of FIG. 5;

FIG. 7 illustrates a circuit diagram of a first output driving block included in the first driver of FIG. 6;

FIG. 8 illustrates a timing diagram of a driving method of the first driver of FIG. 6;

FIG. 9 illustrates a block diagram of a configuration of a second driver in the signal generation group of FIG. 5;

FIG. 10 illustrates a circuit diagram of a second output driving block included in the second driver of FIG. 9;

FIG. 11 illustrates a timing diagram of a driving method of the second driver of FIG. 9;

FIG. 12 is a circuit diagram for a switching unit according to an exemplary embodiment of the scan driver shown in FIG. 4.

FIG. 13 illustrates a timing diagram of a driving method of the switching unit of FIG. 12;

FIG. 14 illustrates a circuit diagram of a switching unit according to another exemplary embodiment of the scan driver of FIG. 4; and

FIG. 15 illustrates a timing diagram of a driving of the switching unit of FIG. 14.

### DETAILED DESCRIPTION

Features will be described more fully hereinafter with reference to the accompanying drawings, in which exemplary embodiments are shown. As those skilled in the art would realize, the described embodiments may be modified in various different ways, all without departing from the spirit or scope of the invention.

In addition, in various exemplary embodiments, the same reference numerals are used in respect to the elements having the same features and illustrated in the first exemplary embodiment, and in other exemplary embodiments, in general, only features that are different from the first exemplary embodiment may be described and/or illustrated.

The drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising,” will be understood to imply the inclusion of stated elements but not the exclusion of any other elements.

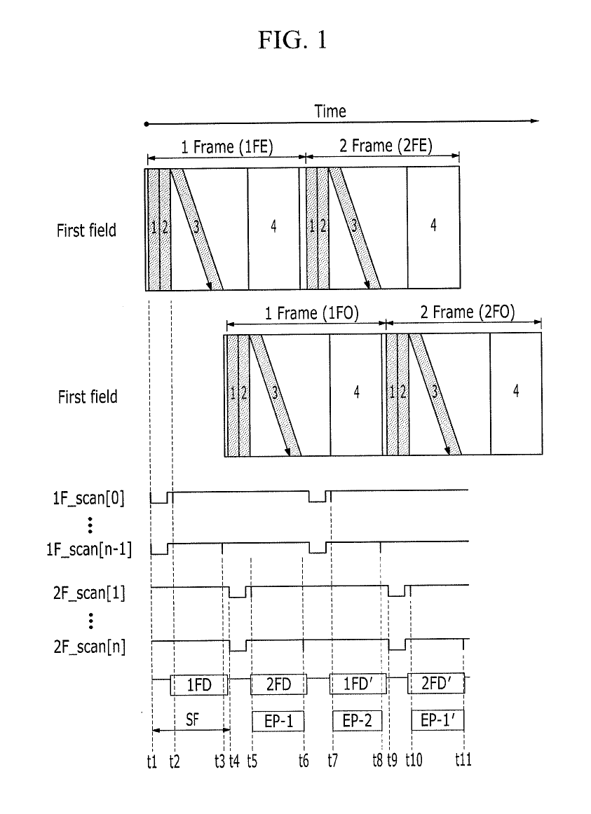

FIG. 1 illustrates a schematic diagram of a driving mode of a display device including a scan driver according to an exemplary embodiment. In detail, FIG. 1 illustrates a driving mode of a display device including a scan driver according to an exemplary embodiment and a timing diagram illustrating writing of a scan signal and data transmitted to a display unit of the display device and light-emitting devices thereof.

FIG. 1 shows that 1 Frame, 2 Frame, and the like are progressed according to the lapse of time.

The driving mode of a display device including a scan driver according to an exemplary embodiment divides a plurality of pixels of a display panel into a plurality of first group pixels emitting light to a first field and a plurality of second group pixels emitting light to a second field. Each of the first field and the second field corresponds to a display period including at least one frame and one frame includes a reset period 1, a compensation period 2, a scan period 3, and a light emitting period 4 in sequence.

Further, the first field and the second field may be driven by being synchronized at the time of moving by a predetermined period SF of time t1 to time t4. In detail, one frame 1F0 of the second field which is temporally adjacent to one frame 1FE of the first field is temporally shifted by the period SF from one frame 1FE. The period SF is set so that the scan periods 3 do not overlap with each other. One frame 2FE of the first field is subsequent to the frame 1 FE and one frame 2F0 of the second field is subsequent to the frame 1FO.

The scan period 3 when a data signal corresponding to each of the second group pixels is written may occur during the light emitting period 4 of the first group pixels. Similarly, the scan period 3 when a data signal corresponding to each of the first group pixels is written may occur during the light emitting period 4 of the second group pixels.

Scan signal 1Fscan[0] to 1Fscan[n−1] are sequentially transferred to the first group pixels, respectively for the scan period 3 of the first group pixels. Further, scan signal 2Fscan[1] to 2Fscan[n] are sequentially transferred to the second group pixels, respectively for the scan period 3 of the second group pixels. In the exemplary embodiment of FIG. 1, scan lines of the entire display panel are set to odd-numbered n, the plurality of pixels connected to the even numbered scan lines are defined as the first group pixels, and the plurality of pixels connected to the odd numbered scan lines are defined as the second group pixels, but the classification of the pixel groups is not limited to FIG. 1.

Meanwhile, the plurality of scan signals may be transferred in sequence for different scan periods for each pixel group and simultaneously, all the scan signals are maintained at a low level for the reset period 1 and the compensation period 3 before the scan period. That is, in FIG. 1, periods of time t1 to time t2, time t4 to time t5, time t6 to time t7, and time t9 to time t10 are the reset periods 1 and the compensation periods 2 of each pixel group and all the scan signals may be maintained at the low level during those periods to activate each pixel. Then, gate electrode voltage of a driving transistor of each pixel may be maintained at the low level to initialize a driving current and compensate for threshold voltage of the driving transistors. Since the driving process of the display device shown in FIG. 1 is unrelated to the scan driver of the exemplary embodiment of the present invention, the detailed description of the driving process is omitted.

As shown in FIG. 1, data signals are sequentially written to the first group of pixels for a period 1FD of time t2 to time t3, which is the scan period in which the scan signals are transferred to the first group pixels. Further, the data signals are sequentially written to the second group pixels for a period 2FD of time t5 to time t6, which is the scan period in which the scan signals are transferred to the second group pixels.

The first group pixels in which the data signals are sequentially written for the period 1FD emit light for the period 2FD when the data signals are written in the second group pixels according to the data signal (EP-1). Similarly, the second group pixels in which the data signals are sequentially written for the period 2FD emit light for a period 1FD′ when the data signals are written in the first group pixels in the next frame according to the data signal (EP-2).

Further, when the scan period crosses the light emitting period for each pixel group, the scan period 3 may be sufficiently ensured, such that a temporal margin for driving the display panel increases. Further, since a scan frequency may be lower, bandwidths of the data driver generating the data signal and transferring the generated data signal to the data line and the scan driver generating the scan signal are decreased, such that a cost of a circuit component may be reduced.

In addition, since the light emitting period 4 of the first group pixel and the light emitting period 4 of the second group pixel are distributed, a necessary maximum current is decreased, such that a cost of a power source circuit supplying power to the display device may be reduced.

As shown in the timing diagram of FIG. 1, the scan driver according to the exemplary embodiment relates to a scan driver designed transfer the plurality of scan signals to the corresponding scan lines in sequence with separate scan periods for the first group pixels and the second group pixels.

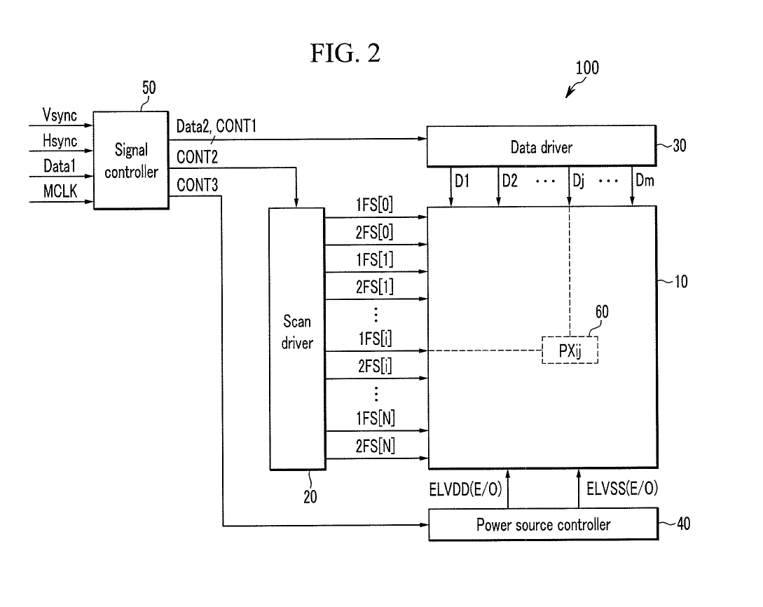

FIG. 2 illustrates a block diagram of a display device 100 including a scan driver 20 according to an exemplary embodiment.

Referring to FIG. 2, the scan driver 20 may be included in the display device 100. More particularly, the display device 100 may include a display unit 10, the scan driver 20, a data driver 30, a power source controller 40, and a signal controller 50.

The display unit 10 includes a plurality of pixels 60 and each pixel 60 emits light to display an image corresponding to a video signal input from the outside.

According to an exemplary embodiment, the display unit 10 may divide the plurality of pixels into a plurality of first pixels included in a first group pixel and a plurality of second pixels included in a second group pixel. Layouts of the plurality of first pixels and the plurality of second pixels may have various configurations in the display unit and are not limited to a predetermined layout form. In one or more embodiments, e.g., the layout form may be a form in which the first pixel and the second pixel overlap each other in the first direction and the second direction, respectively or the plurality of first pixels or a form in which the plurality of second pixels are subsequently disposed in the first direction or the second direction to form one line and each line may be cross-arranged in the second direction or the first direction for each pixel group.

The scan driver 20 is controlled by the signal controller 50 and applies scan signals corresponding to a plurality of scan lines 1FS[0], 2FS[0] to 1FS[N], and 2FS[N] connected to the display unit 10 for every predetermined period (for example, horizontal synchronization signal Hsync period). The scan driver 20 according to the exemplary embodiment of FIG. 2 may transfer the scan signals corresponding to each pixel group to two scan lines respectively connected to each of two pixel groups associated with a plurality of pixel rows included in the display unit 10. That is, since the scan driver 20 is connected to two scan lines corresponding to one pixel row, if the display unit has N pixel rows, the scan driver 20 generates the scan signals to transfer the scan signals to at least 2N scan lines.

For example, the scan driver 20 may transfer a dummy scan signal to the first group pixel of the first pixel row through the scan line 1FS[0] and transfer the dummy scan signal to the second group pixel of the first pixel row through the scan line 2FS[0].

As described above, the scan driver 20 transfers the scan signals to the first group pixels and the second group pixels included in the last pixel row, respectively, through two scan lines 1FS[N] and 2FS[N] connected to the last pixel row of the display unit 10.

The display unit may have various arrangements of a plurality of pixel groups, e.g., the first group pixels or the second group pixels, in one pixel row. Accordingly, two scan lines connected to correspond thereto are disposed to appropriately cross each other, thereby transferring the scan signals corresponding to each of the first group pixel and the second group pixel. The arrangement of the first group pixel and the second group pixel of the display unit and the layout of the plurality of scan lines connected so as to correspond thereto relate to a layout structure may have various forms.

In the exemplary embodiment of FIG. 2, two scan lines are connected to each pixel row corresponding to the two pixel groups shown in FIG. 1, but embodiments are not limited thereto and the number of the scan lines for each pixel row connected to the display unit from the scan driver 20 may vary according to the number of the pixel groups.

The pixels of the display unit 10 connected to each of a plurality of scan lines 1FS[0], 2FS[0] to 1FS[N], 2FS[N] are temporally separated from each other for each pixel group to be activated by the scan signals corresponding to the plurality of scan lines 1FS[0], 2FS[0] to 1FS[N], 2FS[N].

The data driver 30 is controlled by the signal controller 50 and applies data signals to a plurality of data lines D1-Dm connected to the display unit 10 for every predetermined period (for example, vertical synchronization signal Vsync period). When a data signal Data2 corresponding to an external video signal Data1 is transferred to each of the plurality of pixels 60 of the display unit 10 through each of the plurality of data lines D1-Dm, each of the plurality of pixels emits light by a driving current corresponding to the data signal Data2 to display an image.

Further, the power source controller 40 is controlled by the signal controller 50, generates and transfers voltage for driving the pixels 60 included in the display unit 10, and for example, may generate first power source voltage ELVDD and second power source voltage ELVSS to apply the first power source voltage ELVDD and the second power source voltage ELVSS to the plurality of pixels.

In the display device of FIG. 2, the first power source voltage ELVDD and the second power source voltage ELVSS may be separately transferred to the pixel groups of the display unit 10 according to a pixel driving mode of the display unit 10. That is, as an example in FIG. 1, when the pixel group of the display unit 10 is divided into a first group pixel E and a second group pixel O, the power source controller 40 may generate the first power source voltage ELVDD_E applied to the first group pixel E, the first power source voltage ELVDD_O applied to the second group pixel O, the second power source voltage ELVSS_E applied to the first group pixel E, and the second power source voltage ELVSS_O applied to the second group pixel O.

The display unit 10 of the display device of FIG. 2 may be controlled to be driven to be differently dissipated and emitted for each pixel group E/O in one video frame. To this end, the first power source voltage ELVDD_E/O and the second power source voltage ELVSS_E/O which are applied to each pixel group E/O may have at least two times of the first level voltage (for example, high-level voltage having a logic value of 1) and the second level voltage (for example, low level voltage having a logic value of 0) in one video frame.

When the display device is an organic light emitting diode (OLED) display including the display device 10 including pixels 60 emitting light using an organic light emitting diode (OLED), the organic light emitting diode (OLED) of each pixel emits light by a current flowing from a terminal to which the first power source voltage ELVDD_E/O is applied to a terminal to which the second power source voltage ELVSS_E/O is applied. While the second power source voltage ELVSS_E/O is in a high-level state, the current does not flow from the terminal to which the first power source voltage ELVDD_E/O is applied to the terminal to which the second power source voltage ELVSS_E/O is applied, such that the organic light emitting diode (OLED) may be dissipated. In addition, while the second power source voltage ELVSS_E/O is in a low-level state, the current flows from the terminal to which the first power source voltage ELVDD_E/O is applied to the terminal to which the second power source voltage ELVSS_E/O is applied, such that the organic light emitting diode (OLED) may emit light. As described above, when the driving of the display unit 10 is controlled for each pixel group, the light is dissipated and emitted at the same time for each pixel group in one video frame. That is, a video data signal may be written at the same time, and the light may be emitted at the same time for each pixel group in one video frame. Since the power source control of the first power source voltage ELVDD_E/O and the second power source voltage ELVSS_E/O is unrelated to the scan driver according to the exemplary embodiment, the detailed description thereof is omitted.

Meanwhile, the signal controller 50 receives a video signal Data1, a vertical synchronization signal Vsync, a horizontal synchronization signal Hsync, a clock signal MCLK, and the like from the outside, transfers a video data signal Data2 corresponding to the video signal Data1 to the data driver 30, and generates and transfers a control signal controlling each constituent portion of the display device.

In detail, the signal controller 50 generates a scan driving control signal CONT2 controlling the scan driver 20 to transfer the generated scan driving control signal CONT2 to the scan driver 20. Then, the scan driver 20 may be controlled so as to apply the scan signal to the display unit 10 for every predetermined period (for example, a horizontal synchronization signal Hsync period).

Further, the signal controller 50 generates a data driving control signal CONT1 controlling the data driver 30 to transfer the generated data driving control signal CONT1 to the data driver 20 together with the video data signal Data2. Then, the data driver 30 may be controlled so as to apply the video data signal to the display unit 10 for every a predetermined period (for example, a vertical synchronization signal Vsync period).

In addition, the signal controller 50 generates a power source control signal CONT3 controlling the power source controller 40 to transfer the generated power source control signal CONT3 to the power source controller 40. Then, the power source controller 40 may control so as to apply the first power source voltage ELVDD and the second power source voltage ELVSS for each pixel group of the display unit 10. Accordingly, the power source controller 40 may apply the first power source voltages ELVDD_E and ELVDD_O for each pixel group, respectively and also, apply the second power source voltages ELVSS_E and ELVSS_O for each pixel group, respectively. As described above, since the light is dissipated or emitted in one video frame for each pixel group in the display device at the same time and the scan period and the light emitting period are alternately progressed between the pixel groups, the power source controller 40 may control the first power source voltages ELVDD_E and ELVDD_O or the second power source voltages ELVSS_E and ELVSS_O to high-level or low-level voltages by corresponding to the power source control signal CONT3, respectively to apply the controlled voltages to each pixel of the display unit 10.

In more detail, the first power source voltage ELVDD_E and the second power source voltage ELVSS_E applied to the first group pixel E in one video frame may be applied by being controlled so as to have a small difference between the voltage levels in a light dissipating period including the reset period 1, the compensation period 2 while threshold voltage of the driving transistor of the pixel is compensated for, and the scan period 3 while the data voltage is written depending on the video data signal. For example, the second power source voltage ELVSS_E may be transferred at the high-level. Meanwhile, the first power source voltage ELVDD_E and the second power source voltage ELVSS_E may be applied by being controlled so as to have a large difference between the voltage levels in the light emitting period while the pixels of the first group pixel E emit light at the same time according to the video data voltage depending on the written data signal. For example, the first power source voltage ELVDD_E may be transferred by increasing at the high-level or the second power source voltage ELVSS_E may be transferred by decreasing at the low level.

As the display panel is large-sized and the driving modes of the pixel are verified in a sequential or simultaneous light-emitting mode and the like, the circuit configuration of the scan driver 20, which transfers the scan signal to the display unit 10 to activate each pixel of the display unit may be complicated and the output scan signal may also be complicated. Embodiments provide a scan driver configured to employ a relatively small area in a display device while having a circuit design that is relatively simplified, as compared to conventional devices, and a display device including the same in a scan driver applied and driven in a large-sized or high-resolution display device.

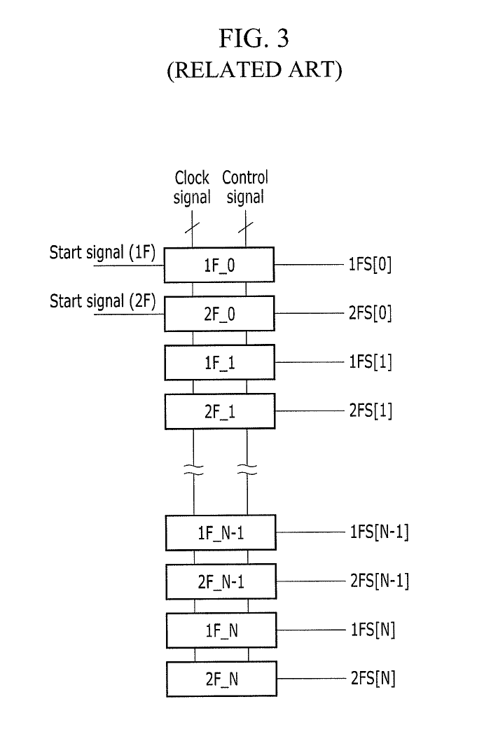

More particularly, e.g., referring to FIG. 3, schematically showing a driving of a scan driver in the related art employable in a display device, the configuration of the scan driver is complicated in the driving mode in which the pixels are divided into the two pixel groups to perform the scanning and the light emitting in turn and emit the light at the same time.

A plurality of signal generators 1F_0 to 2F_N included in the scan driver are divided into the signal generators for the first group pixel E and the signal generators for the second group pixel O to perform outputting. In this case, after the signal generation for the first group pixel E is completed, the signal generation for the second group pixel O starts. According to a pixel structure of the display unit, as shown in FIG. 3, signal generation stages 1F_0, 1F_1 to 1F_N−1, and 1F_N for the first group pixel E and signal generation stages 2F_0, 2F_1 to 2F_N−1, and 2F_N for the second group pixel O are alternately arranged.

Then, the number of the stages for the first group pixel E and the number of the stages for the second group pixel O are added to generate the plurality of scan signals transferred to the display unit. The sum of the number of the stages for the first group pixel E and the number of the stages for the second group pixel O corresponds to the number of the plurality of scan lines connected to the display unit in the scan driver. That is, as shown in FIG. 3, the scan driver has the number of the stage lines two times more than the number of the plurality of pixel rows of the display unit. If the pixel groups are differently divided, the number of the plurality of scan lines increases depending thereon and accordingly, the configuration and the number of the stages of the scan driver are more complicated.

Further, a scan driver circuit including the plurality of signal generators 1F_0 to 2F_N has a complicated circuit configuration in order to receive a clock signal, a control signal, a start signal 1F of the stage for the first group pixel E, and a start signal 2F of the stage for the second group pixel O to generate the plurality of scan signals. For example, in the scan driver in the related art, a signal generation circuit of each stage generating the scan signal may be configured by including seventeen thin film transistors (TFTs) and four capacitors. However, as shown in FIG. 3, in the case of the scan driver generating the scan signal for each pixel group, since the number of the configuration circuit elements may be two times or more, there are problems in the complication of the circuit and the stability of the signal. In addition, since an area in which the circuit elements occupy also increases, it may be difficult to develop the display device seeking slimness and light-weight thereof. Since the detailed circuit configuration for the signal generator of the scan driver is known and unrelated to the present invention, the detailed circuit configuration is omitted.

One or more embodiments of the scan driver 20 is capable of reducing the number of constituent elements and an actual area of the embedded circuit so as to maintain and/or even further reduce the light-weight and the slimness due to the area which the embedded circuit occupies while achieving high resolution of a large-sized display panel.

More particularly, in one or more embodiments, the scan driver 20 includes an embedded circuit capable of generating and outputting the scan signal at a driving timing suitable for the various driving modes of the display device.

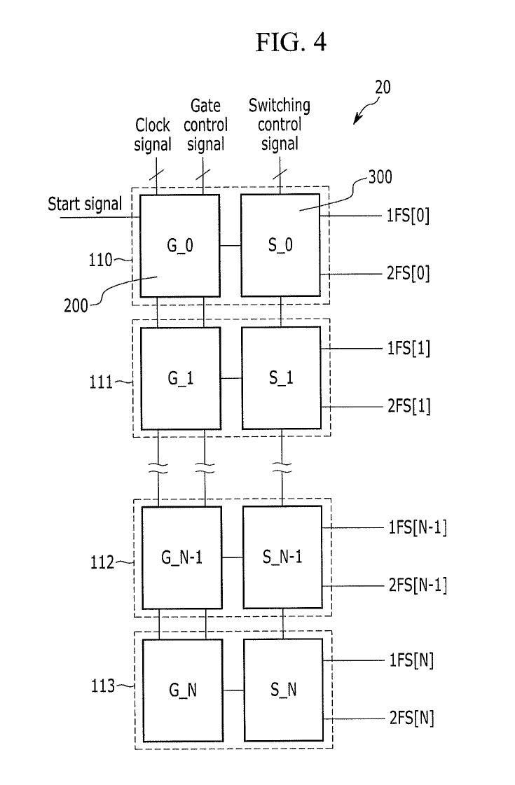

FIG. 4 illustrates a schematic view showing a configuration of the scan driver 20 and a driving method thereof according to an exemplary embodiment.

Referring to FIG. 4, the scan driver 20 includes a plurality of stages 110,111 to 112, 113 which generate and output the scan signals transferred to the display unit. Herein, each of the plurality of stages 110, 111, 112, 113 corresponds to each of the plurality of pixel rows included in the display unit 10 and the number of the stages may also be the same as the number of the pixel rows.

For example, if the number of the pixel rows of the display unit is N, the entire number of the lines of the signal generators of the scan driver in the related art shown in FIG. 3 is at least 2N and the signal generators generate a plurality of scan signals transferred to the pixels of the first group pixel and the second group pixel, respectively.

However, in the scan driver 20 of the exemplary embodiment of FIG. 4, a plurality of signal generators 200 generating the plurality of scan signals transferred to each of the first group pixel and the second group pixel of each pixel row are configured so as to be included in each stage one by one. Accordingly, according to the scan driver 20 of the exemplary embodiment, the signal generators may be configured as many as N which is the number of the stages, such that the circuit configuration is simplified and an area of the scan driver in the display device may be reduced.

The plurality of stages 110, 111 to 112, 113 of the exemplary embodiment of the present invention each transfers the scan signals to the plurality of pixels included in the corresponding pixel rows and the scan signals are separately transferred to the pixels included in the first group pixel and the second group pixel among the plurality of pixels.

As described above, the scan period while the scan signal for the first group pixel E and the scan signal for the second group pixel O are transferred is also divided.

The plurality of stages 110, 111 to 112, 113 according to the exemplary embodiment of the present invention each includes a signal generator 200 and a switching unit 300.

While the start signal is transferred to the signal generator 200 included in the first stage 110, the scan driver 20 operates. A clock signal and a gate control signal are inputted to the signal generator 200 included in the first stage 110. The signal generator 200 of the first stage is driven by receiving the start signal, the clock signal, and the gate control signal to transfer an output signal to the switching unit 300. Then, after the switching unit 300 is driven by using the transferred output signal and the switching control signal, the switching unit 300 generates scan signals to be transferred to the first pixel row of the display unit corresponding to the first stage of the scan driver. In this case, the scan signals includes the scan signals transferred to the first group pixel of the first pixel row and the scan signals transferred to the second group pixel of the first pixel row. That is, the signal generator 200 and the switching unit 300 of the first stage are continuously connected to each other to generate the scan signal transferred to the first group pixel of the first pixel row and transfer the generated scan signal to a dummy scan line 1FS[0]. Further, the signal generator 200 and the switching unit 300 of the first stage generate the scan signal transferred to the second group pixel of the first pixel row to transfer the generated scan signal to a dummy scan line 2FS[0].

In the driving mode of the display device including the scan driver 20 of the exemplary embodiment, after the scan signal is transferred to the display unit, the light is emitted at the same time and the scan period and the light emitting period overlap each other for each of the first group pixel and the second group pixel. Then, in the scan driver 20 according to an exemplary embodiment shown in FIG. 4, the plurality of stages are sequentially driven to generate and transfer the first scan signal groups 1FS[0], 1FS[1] to 1FS[N−1], 1FS[N] including a plurality of scan signals transferred to the first group pixel of the corresponding pixel row and then, generate and transfer the second scan signal groups 2FS[0], 2FS[1] to 2FS[N−1], 2FS[N] including a plurality of scan signals transferred to the second group pixel of the corresponding pixel row.

In the process, the plurality of switching units 300 included in each stage receive the output signals generated from each of the plurality of signal generators 200 to output the scan signals to the scan line transferring the first scan signal groups 1FS[0], 1FS[1] to 1FS[N−1], 1FS[N] to the first group pixel or to the scan line transferring the second scan signal groups 2FS[0], 2FS[1] to 2FS[N−1], 2FS[N] to the second group pixel according to the timing of the switching signal.

Detailed input signals and the circuit configuration and the operation of each stage of the scan driver according to the input signals will be described below with reference to the following drawings.

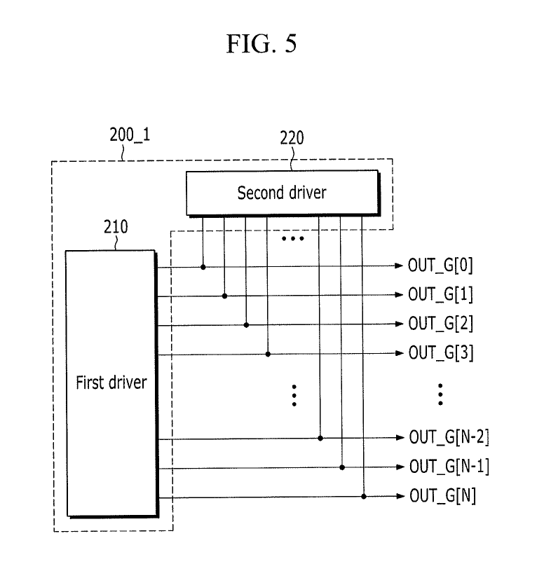

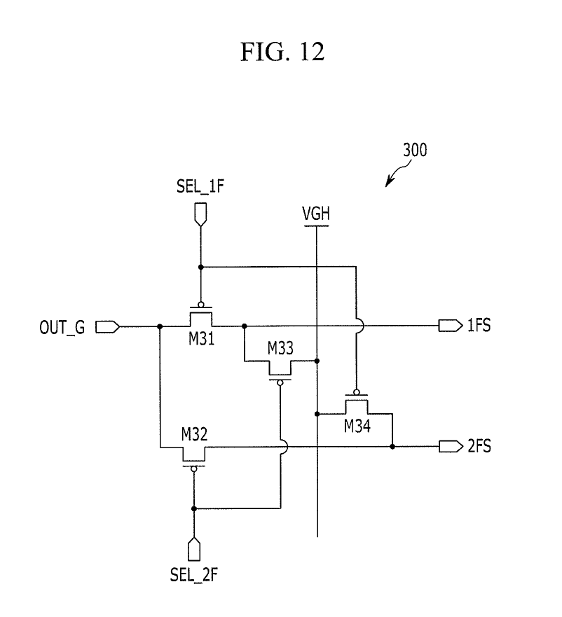

FIGS. 5 to 11 show the circuit configuration and the operation for the scan driver 20 shown in FIG. 4 in detail. Further, the circuit configuration and the operation for the switching unit 300, which receives a plurality of output signals OUT_G outputted from the signal generator 200 to generate the scan signals transferred for each pixel group of the display unit, will be described with reference to FIGS. 12 to 15.

Particularly, the scan driver according to the exemplary embodiment of the present invention is not necessarily limited to the circuit configuration and the operation of the signal generator 200 included in each stage of the scan driver 20 described in the exemplary embodiments of FIGS. 5 to 11. In addition, any circuit performing a necessary function by including the circuit described in the exemplary embodiments of FIGS. 5 to 11 may be used.

A signal generation group 200_1 shown in FIG. 5 corresponds to a set of the signal generators included in each of all the stages of the scan driver and a first driver 210 and a second driver 220 included in the signal generation group 200 corresponds to a set of a plurality of first output driving blocks and a set of a plurality of second output driving blocks corresponding to each stage.

Each of a plurality of output signals OUT_G[1] to OUT_G[N] generated and outputted in the signal generation group 200_1 of FIG. 5 is transferred to the corresponding switching unit through each of the plurality of output lines connecting the signal generator and the switching unit in the stage.

In the exemplary embodiment of FIG. 5, the first driver 210 may be a sequential driver which applies an output signal of gate-on voltage Von to each of the plurality of output lines in sequence and the second driver 220 may be a simultaneous driver which applies the output signal of the gate-on voltage Von to each of the plurality of output lines at the same time.

When the first driver 210 applies the output signal of the gate-on voltage Von to each of the plurality of output lines in sequence, an output terminal of the second driver 220 may be floated. In addition, when the second driver 220 applies the output signal of the gate-on voltage Von to each of the plurality of output lines at the same time, an output terminal of the first driver 210 may be floated. Accordingly, the first driver 210 and the second driver 220 may apply the output signals OUT_G[1] to OUT_G[N] having different waveforms to the same plurality of output lines without influencing each other. The first driver 210 and the second driver 220 are connected to each other by sharing the plurality of output lines to output the corresponding output signals to the switching unit in the corresponding stage.

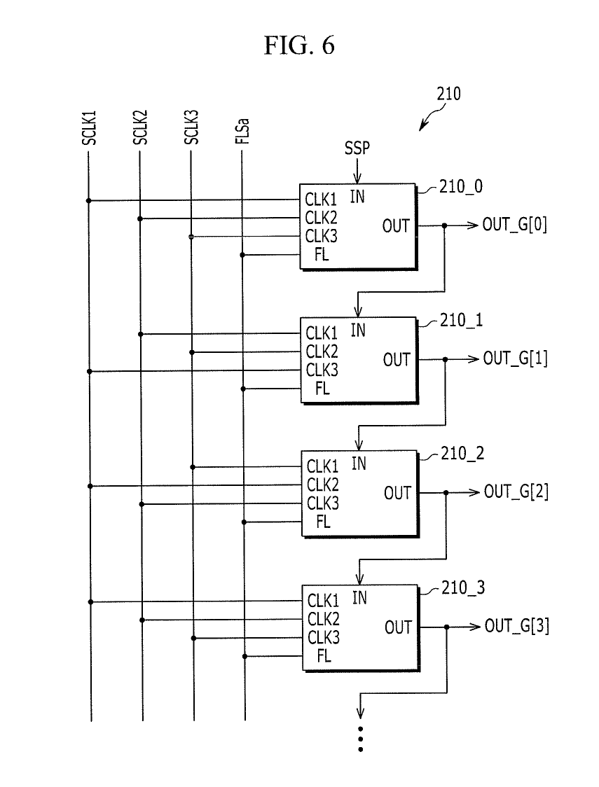

In detail, FIG. 6 illustrates a block diagram of an exemplary configuration of the first driver 210.

Referring to FIG. 6, the first driver 210 includes a plurality of first output driving blocks 210_0, 210_1, 210_2, 210_3, . . . generating a plurality of output signals. The first output driving blocks 210_0, 210_1, 210_2, 210_3, . . . receive input signals to generate output signals OUT_G[0], OUT_G[1], OUT_G[2], OUT_G[3], . . . transferred to each of the plurality of output lines.

The first output driving blocks 210_0, 210_1, 210_2, 210_3, . . . each includes a first clock signal input terminal CLK1, a second clock signal input terminal CLK2, a third clock signal input terminal CLK3, a floating signal input terminal FL, a sequential input terminal IN to which a start signal SSP or an output signal of the adjacent first output driving block is input, and an output signal output terminal OUT_G.

The input signal of each of the first output driving blocks 210_0, 210_1, 210_2, 210_3, . . . includes a plurality of scan clock signals SCLK, a floating signal FLSa, and a start signal SSP or output signals of the adjacent first output driving blocks. The plurality of scan clock signals SCLK includes a first scan clock signal SCLK1, a second scan clock signal SCLK2, and a third scan clock signal SCLK3. The plurality of scan clock signals SCLK1, SCLK2, and SCLK3 and the floating signal FLSa are applied to different wirings.

Three subsequent first output driving blocks receive three scan clock signals SCLK1, SCLK2, and SCLK3 at different input terminals. For example, in the first of the first output driving block 210_0, the first clock signal input terminal CLK1 is connected to a wiring of the first scan clock signal SCLK1, the second clock signal input terminal CLK2 is connected to a wiring of the second scan clock signal SCLK2, and the third clock signal input terminal CLK3 is connected to a wiring of the third scan clock signal SCLK3.

In the second of the first output driving block 210_1, the first clock signal input terminal CLK1 is connected to a wiring of the second scan clock signal SCLK2, the second clock signal input terminal CLK2 is connected to a wiring of the third scan clock signal SCLK3, and the third clock signal input terminal CLK3 is connected to a wiring of the first scan clock signal SCLK1.

In the third of the first output driving block 210_2, the first clock signal input terminal CLK1 is connected to a wiring of the third scan clock signal SCLK3, the second clock signal input terminal CLK2 is connected to a wiring of the first scan clock signal SCLK1, and the third clock signal input terminal CLK3 is connected to a wiring of the second scan clock signal SCLK2.

That is, the three scan clock signals SCLK1, SCLK2, and SCLK3 are input to the clock signal input terminals CLK1, CLK2, and CLK3 of the plurality of first output driving blocks 210_0, 210_1, 210_2, 210_3, . . . in three types. Between the adjacent first output driving blocks of the plurality of first output driving blocks 210_0, 210_1, 210_2, 210_3, . . . , the plurality of scan clock signals SCLK1, SCLK2, and SCLK3 input to the plurality of clock signal input terminals CLK1, CLK2, and CLK3 are differently input.

The floating signal input terminal FL of each of the first output driving blocks 210_0, 210_1, 210_2, 210_3, . . . is connected to a wiring of the floating signal FLSa.

Each of the first output driving blocks 210_0, 210_1, 210_2, 210_3, . . . outputs output signals OUT_G[0], OUT_G[1], OUT_G[2], OUT_G[3], . . . generated according to signals input to the plurality of clock signal input terminals CLK1, CLK2, and CLK3, the floating signal input terminal FL, and the sequential input terminal IN to the output signal output terminal OUT_G. The plurality of first output driving blocks 2100, 210_1, 210_2, 210_3, . . . output the output signals in sequence according to the input of the start signal SSP or the output signal of the adjacent first output driving block.

The first of the first output driving block 210_0 receives the start signal SSP to transfer the generated output signal OUT_G[0] to a dummy output line and the second of the first output driving block 210_1. The second of the first output driving block 210_1 receives the output signal OUT_G[0] of the first of the first output driving block 210_0 to transfer the generated output signal OUT_G[1] to the second output line and the third of the first output driving block 210_2. The third of the first output driving block 210_2 receives the output signal OUT_G[1] of the second of the first output driving block 210_1 to transfer the generated output signal OUT_G[2] to the third output line and the fourth of the first output driving block 210_3. That is, the first output driving block arranged in the k+1-th receives an output signal OUT_G[k] output from the first output driving block arranged in the k-th which is the adjacent first output driving block to output the generated output signal OUT_G[k+1] (1<=k<n). As described above, the output signals are sequentially generated from the first of the first output driving block 210_0 to the N-th of the first output driving block (not shown) to be transferred to the plurality of output lines.

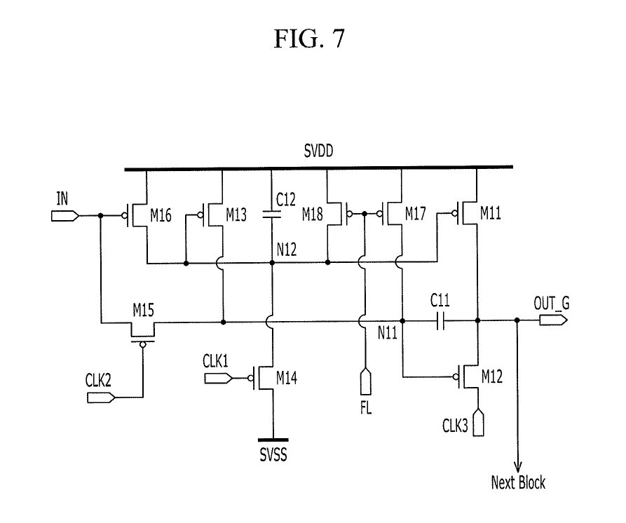

FIG. 7 illustrates a circuit diagram of the first output driving blocks 210_0, 210_1, 210_2, 210_3, . . . included in the first driver 210 of FIG. 6.

Referring to FIG. 7, the first output driving block includes a plurality of input terminals CLK1, CLK2, CLK3, IN, and FL, an output signal output terminal OUT_G, a plurality of transistors M11, M12, M13, M14, M15, M16, M17, and M18, and a plurality of capacitors C11 and C12.

The plurality of input terminals include a first clock signal input terminal CLK1, a second clock signal input terminal CLK2, a third clock signal input terminal CLK3, a floating signal input terminal FL, and a sequential input terminal IN.

The first transistor M11 includes a gate electrode connected to a second node N12, one terminal connected to a SVDD power source, and the other terminal connected to the output signal output terminal OUT_G. The second transistor M12 includes a gate electrode connected to a first node N11, one terminal connected to the third clock signal input terminal CLK3, and the other terminal connected to the output signal output terminal OUT_G. The third transistor M13 includes a gate electrode connected to the second node N12, one terminal connected to the SVDD power source, and the other terminal connected to the first node N11. The fourth transistor M14 includes a gate electrode connected to the first clock signal input terminal CLK1, one terminal connected to the SVSS power source, and the other terminal connected to the second node N12. The fifth transistor M15 includes a gate electrode connected to the second clock signal input terminal CLK2, one terminal connected to the sequential input terminal IN, and the other terminal connected to the first node N11. The sixth transistor M16 includes a gate electrode connected to the sequential input terminal IN, one terminal connected to the SVDD power source, and the other terminal connected to the second node N12. The seventh transistor M17 includes a gate electrode connected to the floating signal input terminal FL, one terminal connected to the SVDD power source, and the other terminal connected to the first node N11. The eighth transistor M18 includes a gate electrode connected to the floating signal input terminal FL, one terminal connected to the SVDD power source, and the other terminal connected to the second node N12.

The first capacitor C11 includes one terminal connected to the first node N11 and the other terminal connected to the output signal output terminal OUT_G. The second capacitor C12 includes one terminal connected to the SVDD power source and the other terminal connected to the second node N 12.

The first node N11 is connected to the gate electrode of the second transistor M12, the other terminal of the third transistor M13, the other terminal of the fifth transistor M15, the other terminal of the seventh transistor M17, and one terminal of the first capacitor C11. The second node N12 is connected to the gate electrode of the first transistor M11, the gate electrode of the third transistor M13, the other terminal of the fourth transistor M14, the other terminal of the sixth transistor M16, the other terminal of the eighth transistor M18, and the other terminal of the second capacitor C12.

The SVDD power source is a power source having high-level voltage (for example, a state having a logic value of 1) and the SVSS power source is a power source having low-level voltage (for example, a state having a logic value of 0).

The plurality of transistors M11, M12, M13, M14, M15, M16, M17, and M18 may be p-channel field effect transistors. Gate-on voltage turning on the plurality of transistors M11, M12, M13, M14, M15, M16, M17, and M18 is the low-level voltage and gate-off voltage turning off the plurality of transistors M11, M12, M13, M14, M15, M16, M17, and M18 is the high-level voltage.

At least one of the plurality of transistors M11, M12, M13, M14, M15, M16, M17, and M18 may be an n-channel field effect transistor and gate-on voltage turning on the n-channel field effect transistor is the high-level voltage and gate-off voltage turning off the n-channel field effect transistor is the low-level voltage.

The first scan clock signal SCLK1, the second scan clock signal SCLK2, and the third scan clock signal SCLK3 may be applied at the low-level voltage in different periods. That is, the signals inputted to the first clock signal input terminal CLK1, the second clock signal input terminal CLK2, and the third clock signal input terminal CLK3 may be applied at the low-level voltage in different periods.

When the low-level voltage is applied to the first clock signal input terminal CLK1 and the high-level voltage is applied to the sequential input terminal IN, the fourth transistor M14 is turned on and SVSS power source voltage is transferred to the gate electrode of the first transistor M11 to turn on the first transistor M11. The SVDD power source voltage is output to the output signal output terminal OUT_G through the first transistor M11. That is, a high-level output signal is output. In this case, the sixth transistor M16 is turned off, the third transistor M13 is turned on, and the SVDD power source voltage is transferred to the gate electrode of the second transistor M12 through the third transistor M13 to turn off the second transistor M12.

When the low-level voltage is applied to the second clock signal input terminal CLK2 and the low-level voltage is applied to the sequential input terminal IN, the fifth transistor M15 is turned on and the low-level voltage applied to the sequential input terminal IN is transferred to the gate electrode of the second transistor M12 to turn on the second transistor M12. The high-level voltage input to the third clock signal input terminal CLK3 is outputted to the output signal output terminal OUT_G. In addition, the low-level voltage is applied to one terminal of the first capacitor C11 and the high-level voltage is applied to the other terminal thereof to charge the first capacitor C11. In this case, the sixth transistor M16 is turned on and the SVDD power source voltage is transferred to the gate electrode of the first transistor M11 and the gate electrode of the third transistor M13 to turn off the first transistor M11 and the third transistor M13.

When the low-level voltage is applied to the third clock signal input terminal CLK3 and the high-level voltage is applied to the sequential input terminal IN, the first transistor M11, the third transistor M13, the fourth transistor M14, the fifth transistor M15, and the sixth transistor M16 are turned off. While the voltage applied to the third clock signal input terminal CLK3 is changed from the high-level voltage to the low-level voltage, the voltage of the first node N11 drops to voltage lower than the low-level voltage (SVSS power source voltage) by a bootstrap operation of the first capacitor C11. Accordingly, the second transistor M12 is completely turned on and the low-level voltage is outputted to the output signal output terminal OUT_G through the turned-on second transistor M12.

In the process (scan enable state) in which the low-level voltage is applied to the three clock signal input terminals CLK1, CLK2, and CLK3, the high-level voltage is applied to the floating signal input terminal FL. In the floating section floating the output terminal of the first driver 210, the low-level voltage is applied to the floating signal input terminal FL.

When the high-level voltage is applied to the floating signal input terminal FL, the seventh transistor M17 and the eighth transistor M18 are turned off and do not influence voltage applied to the gate electrode of the first transistor M11 and the gate electrode of the second transistor M12. When the low-level voltage is applied to the floating signal input terminal FL, the seventh transistor M17 and the eighth transistor M18 are turned on, the SVDD power source voltage is transferred to the gate electrode of the second transistor M12 through the turned-on seventh transistor M17 to turn off the second transistor M12, and the SVDD power source voltage is transferred to the gate electrode of the first transistor M11 through the turned-on eighth transistor M18 to turn off the first transistor M11. That is, the seventh transistor M17 transfers the high-level voltage turning off the second transistor M12 depending on the floating signal FLSa. The eighth transistor M18 transfers the high-level voltage turning off the first transistor M11 depending on the floating signal FLSa. Accordingly, the output signal output terminal OUT_G is floated.

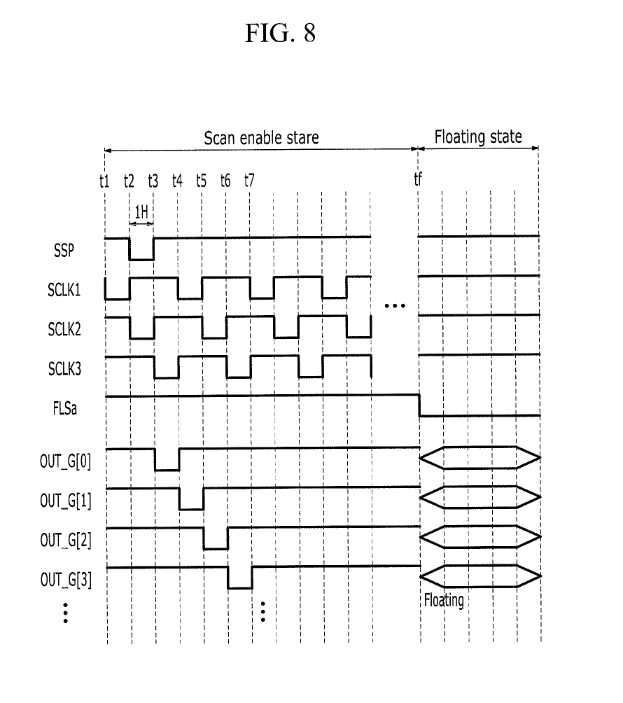

FIG. 8 is a timing diagram illustrating a driving method of the first driver of FIG. 6. The driving method of the first driver will be described with reference to FIGS. 6 and 7 together with the timing diagram of FIG. 8.

Referring to FIG. 8, in the scan driver, the first driver operates in a scan enable state in which the floating signal FLSa is applied at the high-level voltage turning off the seventh transistor M17 and the eighth transistor M18 and in a floating state in which the floating signal FLSa is applied at the low-level voltage turning on the seventh transistor M17 and the eighth transistor M18.

In the scan enable state, the first scan clock signal SCLK1, the second scan clock signal SCLK2, and the third scan clock signal SCLK3 are applied at the low-level voltage in different periods by a unit of 1 horizontal period 1H (the same as a period of a horizontal synchronization signal Hsync). A section in which the voltage turning on a transistor included in the first output driving block of one period of the clock signal is applied is referred to as a duty of the clock signal. The second scan clock signal SCLK2 is a signal in which the first scan clock signal SCLK1 is shifted by a duty of the first scan clock signal SCLK1 and the third scan clock signal SCLK3 is a signal in which the second scan clock signal SCLK2 is shifted by a duty of the second scan clock signal SCLK2. Herein, a period of the first scan clock signal SCLK1, the second scan clock signal SCLK2, and the third scan clock signal SCLK3 is 3 horizontal period and each of the scan clock signals SCLK1, SCLK2, and SCLK3 is a signal shifted by the 1 horizontal period.

In a section t1 to t2, the first scan clock signal SCLK1 is applied at the low-level voltage. Since the first scan clock signal SCLK1 is input to the first clock signal input terminal CLK1 of the first of the output driving block 210_0, the first of the first output driving block 210_0 outputs the high-level output signal OUT_G[0].

In a section t2 to t3, the second scan clock signal SCLK2 and the start signal SSP are applied at the low-level voltage. Since the second scan clock signal SCLK2 is inputted to the second clock signal input terminal CLK2 of the first of the first output driving block 2100 and the start signal SSP is input to the sequential input terminal IN of the first of the first output driving block 210_0, the first of the first output driving block 210_0 outputs the high-level output signal OUT_G[0]. In this case, the low-level voltage is applied to one terminal of the first capacitor C11 of the first of the first output driving block 210_0 and the high-level voltage is applied to the other terminal thereof.

In a section t3 to t4, the third scan clock signal SCLK3 is applied at the low-level voltage. Since the third scan clock signal SCLK3 is inputted to the third clock signal input terminal CLK3 of the first of the first output driving block 210_0, the first of the first output driving block 210_0 transfers the low-level voltage to the output signal output terminal OUT_G through the second transistor M12 which is completely turned on by the bootstrap through the first capacitor C11 to output the low-level output signal OUT_G[0].

Meanwhile, the second of the first output driving block 210_1 receives the low-level output signal OUT_G[0] of the first of the first output driving block 210_0 at the sequential input terminal IN in the section t3 to t4 and receives the low-level third scan clock signal SCLK3 at the second clock signal input terminal CLK2. The second of the first output driving block 210_1 outputs the high-level output signal OUT_G[1] to charge the first capacitor C11.

In a section t4 to t5, the first scan clock signal SCLK1 is applied at the low-level voltage and the first scan clock signal SCLK1 is input to the third clock signal input terminal CLK3 of the second of the first output driving block 210_1. The second of the first output driving block 210_1 transfers the low-level voltage to the output signal output terminal OUT_G through the second transistor M12 which is completely turned on by the bootstrap through the first capacitor C11 to output the low-level output signal OUT_G[1].

In the section t4 to t5, the third of the first output driving block 210_2 receives the low-level output signal OUT_G[1] of the second of the first output driving block 210_1 at the sequential input terminal IN and receives the low-level first scan clock signal SCLK1 at the second clock signal input terminal CLK2. The third of the first output driving block 210_2 outputs the high-level output signal OUT_G[2] to charge the first capacitor C11.

In a section t5 to t6, the second scan clock signal SCLK2 is applied at the low-level voltage and the second scan clock signal SCLK2 is inputted to the third clock signal input terminal CLK3 of the third of the first output driving block 210_2. The third of the first output driving block 210_2 transfers the low-level voltage to the output signal output terminal OUT_G through the second transistor M12 which is completely turned on by the bootstrap through the first capacitor C11 to output the low-level output signal OUT_G[2].

Since the fourth of the first output driving block 210_3 is connected to the wirings of the plurality of scan clock signals SCLK1, SCLK2, and SCLK3 like the first of the first output driving block 210_0, the same scan clock signals SCLK1, SCLK2, and SCLK3 are inputted to each of the input terminals CLK1, CLK2, and CLK3. The fourth of the first output driving block 210_3 outputs the low-level output signal OUT_G[3] in a section t6 to t7.

As described above, in the scan enable state, the first driver 210 may sequentially output the output signals by using the first scan clock signal SCLK1, the second scan clock signal SCLK2, the third scan clock signal SCLK3, and the start signal SSP or the output signal of the adjacent first output driving block which are applied at the low-level voltage in different periods. When the periods of the first scan clock signal SCLK1, the second scan clock signal SCLK2, and the third scan clock signal SCLK3 are 3 horizontal periods and the duty is a 1 horizontal period, the plurality of output signals having the duty of the 1 horizontal period are shifted by 1 horizontal period to be sequentially outputted to the plurality of output lines connected to the switching unit corresponding to the signal generator in one stage.

The first driver 210 operates in the floating state in which the output signal output terminal OUT_G is floated from a time tf when the floating signal FLSa is applied at the low-level voltage. In the operation in the floating state, the start signal SSP and each of the scan clock signals SCLK1, SCLK2, and SCLK3 are applied at the high-level voltage. When the floating signal FLSa is applied at the low-level voltage, the SVDD power source voltage is applied to both the first node N11 and the second node N12 and thus, the first transistor M11 and the second transistor M12 are turned off and the output signal output terminal OUT_G is floated. Accordingly, the first driver 210 does not influence any other signals applied to the plurality of output lines connected to the switching unit in the state where the output terminal is floated.

When the floating signal FLSa is applied at the high-level voltage again, the first driver 210 returns to the scan enable state to output the output signals to the plurality of output lines.

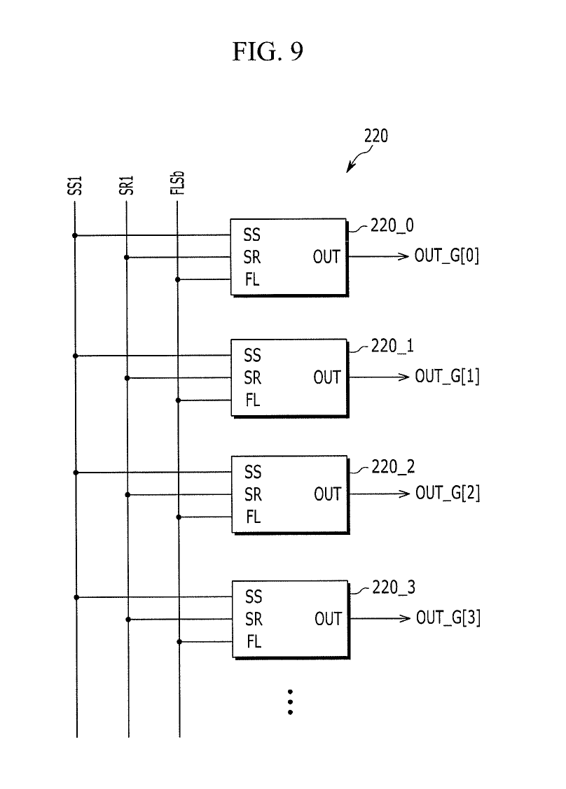

Meanwhile, FIG. 9 is a block diagram illustrating a configuration of a second driver 220 in the signal generation group of FIG. 5.

Referring to FIG. 9, the second driver 220 includes a plurality of second output driving blocks 220_0, 220_1, 220_2, 220_3, . . . generating a plurality of output signals.

The second output driving blocks 220_0, 220_1, 220_2, 220_3, . . . receive input signals to generate output signals OUT_G[0], OUT_G[1], OUT_G[2], OUT_G[3], transferred to each of the plurality of output lines.

The second output driving blocks 220_0, 220_1, 220_2, 220_3, . . . each includes a first control signal input terminal SS, a second control signal input terminal SR, a floating signal input terminal FL, and an output signal output terminal OUT_G.

The input signal of each of the second output driving blocks 220_0, 220_1, 220_2, 220_3, . . . includes a first control signal SS1, a second control signal SR1, and a floating signal FLSb. The plurality of control signals SS1 and SR1 and the floating signal FLSb are applied to different wirings.

The first control signal input terminal SS of each of the second output driving blocks 220_0, 220_1, 220_2, 220_3, . . . is connected to a wiring of the first control signal SS1, the second control signal input terminal SR is connected to a wiring of the second control signal SR1, and the floating signal input terminal FL is connected to a wiring of the floating signal FLSb.

Each of the second output driving blocks 220_0, 220_1, 220_2, 220_3, . . . outputs the output signals OUT_G[0], OUT_G[1], OUT_G[2], OUT_G[3], . . . generated depending on signals input to the first control signal input terminal SS, the second control signal input terminal SR, and the floating signal input terminal FL to the output signal output terminal OUT_G. Each of the second output driving blocks 220_0, 220_1, 220_2, 220_3, . . . outputs the output signals OUT_G[0], OUT_G[1], OUT_G[2], OUT_G[3], . . . at the same time.

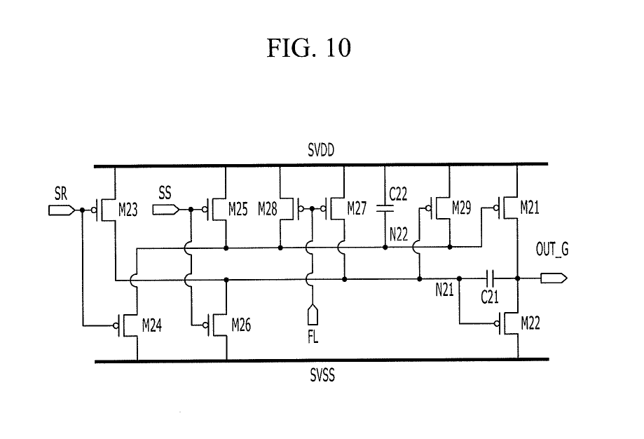

FIG. 10 illustrates a circuit diagram of the second output driving blocks 220_0, 220_1, 220_2, 220_3, . . . included in the second driver 220 of FIG. 9

Referring to FIG. 10, the second output driving blocks 220_0, 220_1, 220_2, 220_3, . . . include a first control signal input terminal SS, a second control signal input terminal SR, an output signal output terminal OUT_G, a plurality of transistors M21, M22, M23, M24, M25, M26, M27, M28, and M29 and a plurality of capacitors C21 and C22.

The first transistor M21 includes a gate electrode connected to a second node N22, one terminal connected to a SVDD power source, and the other terminal connected to the output signal output terminal OUT_G. The second transistor M22 includes a gate electrode connected to a first node N21, one terminal connected to the SVSS power source, and the other terminal connected to the output signal output terminal OUT_G. The third transistor M23 includes a gate electrode connected to the second control signal input terminal SR, one terminal connected to the SVDD power source, and the other terminal connected to the first node N21. The fourth transistor M24 includes a gate electrode connected to the second control signal input terminal SR, one terminal connected to the SVSS power source, and the other terminal connected to the second node N22. The fifth transistor M25 includes a gate electrode connected to the first control signal input terminal SS, one terminal connected to the SVDD power source, and the other terminal connected to the second node N22. The sixth transistor M26 includes a gate electrode connected to the first control signal input terminal SS, one terminal connected to the SVSS power source, and the other terminal connected to the first node N21. The seventh transistor M27 includes a gate electrode connected to the floating signal input terminal FL, one terminal connected to the SVDD power source, and the other terminal connected to the first node N21. The eighth transistor M28 includes a gate electrode connected to the floating signal input terminal FL, one terminal connected to the SVDD power source, and the other terminal connected to the second node N22.

The ninth transistor M29 includes a gate electrode connected to the first node N21, one terminal connected to the SVDD power source, and the other terminal connected to the second node N22.

The first capacitor C21 includes one terminal connected to the first node N21 and the other terminal connected to the output signal output terminal OUT_G. The second capacitor C22 includes one terminal connected to the SVDD power source and the other terminal connected to the second node N22.

The first node N21 is connected to the gate electrode of the second transistor M22, the gate electrode of the ninth transistor M29, the other terminal of the third transistor M23, the other terminal of the sixth transistor M26, the other terminal of the seventh transistor M27, and one terminal of the first capacitor C21. The second node N22 is connected to the gate electrode of the first transistor M21, the other terminal of the fourth transistor M24, the other terminal of the fifth transistor M25, the other terminal of the eighth transistor M28, the other terminal of the ninth transistor M29, and the other terminal of the second capacitor C22.

The SVDD power source is a power source having high-level voltage and the SVSS power source is a power source having low-level voltage.

The plurality of transistors M21, M22, M23, M24, M25, M26, M27, M28, and M29 may be p-channel field effect transistors or n-channel field effect transistors. FIG. 10 shows the circuit diagram by the p-channel field effect transistor and the plurality of transistors are turned on at the low-level voltage and turned off at the high-level voltage.

When the low-level voltage is applied to the first control signal input terminal SS and the high-level voltage is applied to the second control signal input terminal SR, the third transistor M23 and the fourth transistor M24 are turned off and the fifth transistor M25 and the sixth transistor M26 are turned on. The SVDD power source voltage is transferred to the gate electrode of the first transistor M21 through the turned-on fifth transistor M25 to turn off the first transistor M21 and the SVSS power source voltage is transferred to the gate electrode of the second transistor M22 through the turned-on sixth transistor M26. In this case, the voltage of the first node N21 becomes lower than the SVSS power source voltage by the bootstrap of the first capacitor C21. Accordingly, the second transistor M22 is completely turned on and the SVSS power source voltage is outputted to the output signal output terminal OUT_G through the turned-on second transistor M22. That is, a low-level output signal is outputted.

When the high-level voltage is applied to the first control signal input terminal SS and the low-level voltage is applied to the second control signal input terminal SR, the fifth transistor M25 and the sixth transistor M26 are turned off and the third transistor M23 and the fourth transistor M24 are turned on. The SVDD power source voltage is transferred to the gate electrode of the second transistor M22 through the turned-on third transistor M23 to turn off the second transistor M22. The SVSS power source voltage is transferred to the gate electrode of the first transistor M21 through the turned-on fourth transistor M24 to turn on the first transistor M21. The SVDD power source voltage is outputted to the output signal output terminal OUT_G through the turned-on first transistor M21. That is, a high-level output signal is outputted.

When the high-level voltage is applied to the floating signal input terminal FL, the seventh transistor M27 and the eighth transistor M28 are turned off and do not influence the voltage applied to the gate electrode of the first transistor M21 and the gate electrode of the second transistor M22. When the low-level voltage is applied to the floating signal input terminal FL, the seventh transistor M27 and the eighth transistor M28 are turned on, the SVDD power source voltage is transferred to the gate electrode of the second transistor M22 through the turned-on seventh transistor M27 to turn off the second transistor M22, and the SVDD power source voltage is transferred to the gate electrode of the first transistor M21 through the turned-on eighth transistor M28 to turn off the first transistor M21. Accordingly, the output signal output terminal OUT_G is floated.

In this case, the high-level voltage is applied to the first control signal input terminal SS and the second control signal input terminal SR.

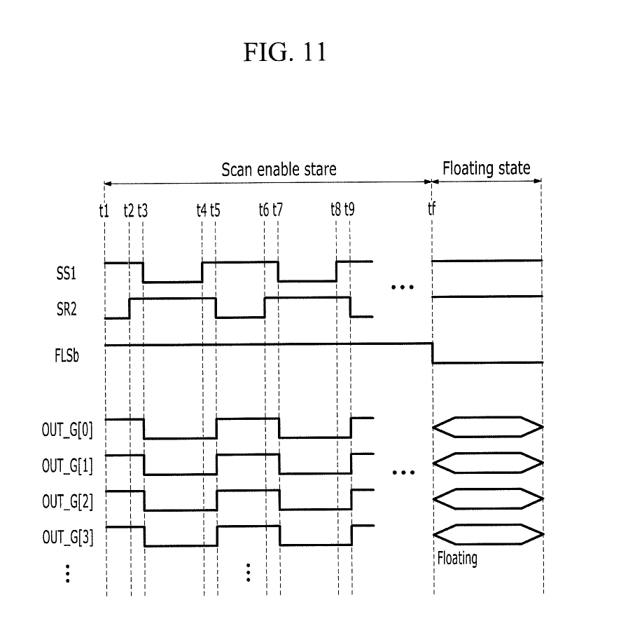

FIG. 11 illustrates a timing diagram of a driving method of the second driver 220 of FIG. 9. The timing diagram of FIG. 11 will be described with reference to FIGS. 9 and 10 together.

As shown in FIG. 11, the second driver 220 operates in a scan enable state in which the floating signal FLSa is applied at the high-level voltage and in a floating state in which the floating signal FLSa is applied at the low-level voltage.

In the scan enable state, the first control signal SS1 and the second control signal SR1 have different pulse widths and are generally applied to different polarities. For example, the first control signal SS1 is applied at the high-level voltage in a section t1 to t3, the low-level voltage in a section t3 to t4, and the high-level voltage in a section t4 to t7. In this case, the second control signal SR1 is applied at the low-level voltage in a section t1 to t2, the high-level voltage in a section t2 to t5, and the low-level voltage in a section t5 to t6. That is, the section where the first control signal SS1 is applied at the low-level voltage is included in the section where the second control signal SR1 is applied at the high-level voltage and the section where the second control signal SR1 is applied at the low-level voltage is included in the section where the first control signal SS1 is applied at the high-level voltage.

In the section t1 to t2, the first control signal SS1 is applied at the high-level voltage and the second control signal SR1 is applied at the low-level voltage. Each of the second output driving blocks 2200, 220_1, 220_2, 220_3, . . . outputs the high-level output signals OUT_G[0], OUT_G[1], OUT_G[2], OUT_G[3], . . . .

In the section t2 to t3, while the first control signal SS1 is applied at the high-level voltage, the second control signal SR1 is converted into the high-level voltage to be applied. The third transistor M23, the fourth transistor M24, the fifth transistor M25, and the sixth transistor M26 of the second output driving block are turned off. Meanwhile, in the section t1 to t2, the SVDD power source voltage is applied to one terminal of the second capacitor C22 and the SVSS power source voltage is applied to the other terminal thereof to charge the second capacitor C22. That is, the SVSS power source voltage is formed at the second node N22, the voltage formed at the second node N22 is applied to the gate electrode of the first transistor M21 in the section t2 to t3 to turn on the first transistor M21, and the SVDD power source voltage is outputted to the output signal output terminal OUT_G through the turned-on first transistor M21. That is, each of the second output driving blocks 220_0, 220_1, 220_2, 220_3, . . . outputs the high-level output signals OUT_G[0], OUT_G[1], OUT_G[2], OUT_G[3], . . . .

In the section t3 to t4, while the second control signal SR1 is applied at the high-level voltage, the first control signal SS1 is converted into the low-level voltage to be applied. Each of the second output driving blocks 220_0, 220_1, 220_2, 220_3, . . . outputs the low-level output signals OUT_G[0], OUT_G[1], OUT_G[2], OUT_G[3], . . . .

In the state (the section t1 to t2) where the first control signal SS1 is the high-level voltage and the second control signal SR1 is the low-level voltage, first, the second control signal SR1 is converted into the high-level voltage (time t2) and next, the first control signal SS1 is converted into the low-level voltage (time t3)

Accordingly, power consumption may be reduced by preventing a short-circuit current flowing from the SVDD power source to the SVSS power source.

In the section t4 to t5, while the second control signal SR1 is applied at the high-level voltage, the first control signal SS1 is converted into the high-level voltage to be applied. The voltage of the first node N21 becomes lower than the SVSS power source voltage by the bootstrap of the first capacitor C21. In the section t4 to t5, the voltage of the first node N21 is applied to the gate electrode of the second transistor M22 to turn on the second transistor M22 and the SVSS power source voltage is outputted to the output signal output terminal OUT_G through the turned-on second transistor M22. That is, each of the second output driving blocks 220_0, 220_1, 220_2, 220_3, . . . outputs the low-level output signals OUT_G[0], OUT_G[1], OUT_G[2], OUT_G[3], . . . .

In the section t5-t6, while the first control signal SS1 is applied at the high-level voltage, the second control signal SR1 is converted into the low-level voltage to be applied. Each of the second output driving blocks 220_0, 220_1, 220_2, 220_3, . . . outputs the high-level output signals OUT_G[0], OUT_G[1], OUT_G[2], OUT_G[3], . . . .

In the state (the section t3 to t4) where the first control signal SS1 is the low-level voltage and the second control signal SR1 is the high-level voltage, first, the first control signal SS1 is converted into the high-level voltage (time t4) and next, the second control signal SR1 is converted into the low-level voltage (time t5)

Accordingly, power consumption may be reduced by preventing a short-circuit current flowing from the SVDD power source to the SVSS power source.

In the section t6 to t7, while the first control signal SS1 is applied at the high-level voltage, the second control signal SR1 is converted into the high-level voltage to be applied. Each of the second output driving blocks 220_0, 220_1, 220_2, 220_3, . . . outputs the high-level output signals OUT_G[0], OUT_G[1], OUT_G[2], OUT_G[3], . . . .

As described above, the low-level output signals are outputted from the time 3 when the first control signal SS1 is converted into the low-level voltage to the time t5 when the second control signal SR1 is converted into the low-level voltage.

The second driver 220 may control the pulse widths of the first control signal SS1 and the second control signal SR1 and accordingly, the time when the low-level output signals are outputted to the plurality of output lines connected to the corresponding switching unit may be controlled.

The second driver 220 operates in the floating state in which the output signal output terminal OUT_G is floated from a time tf when the floating signal FLSb is applied at the low-level voltage. In the operation in the floating state, the first control signal SS1 and the second control signal SR1 are applied at the high-level voltage. When the floating signal FLSb is applied at the low-level voltage, the SVDD power source voltage is applied to both the first node N21 and the second node N22 and then, the first transistor M21 and the second transistor M22 are turned off and the output signal output terminal OUT_G is floated. Accordingly, the second driver 220 does not influence other signals applied to the plurality of output lines in the state where the output terminal is floated.

When the floating signal FLSb is applied at the high-level voltage again, the second driver 220 returns to the scan enable state to generate the output signals outputted at the low level and the high level at once.

Particularly, in the section (for example, the section t3 to t5) when each of the second output driving blocks 220_0, 220_1, 220_2, 220_3, . . . outputs the low-level output signals OUT_G[0], OUT_G[1], OUT_G[2], OUT_G[3], . . . , the voltage lower than the SVSS power source voltage is formed at the first node N21 by the bootstrap of the first capacitor C21, the voltage of the first node N21 turns on the ninth transistor M29, and the SVDD power source voltage is transferred to the second node N22 through the turned-on ninth transistor M29, such that the voltage of the second node N22 may be more certainly maintained as the SVDD power source voltage.

According to the exemplary embodiment of FIGS. 5 to 11, the scan driver of one or more embodiments sequentially generates the output signals for each stage by the first driver 210 of the signal generation group 200_1 according to the driving mode to transfer the generated output signals to the corresponding switching unit 300 of the corresponding stage, or simultaneously generates the output signals in all the stages by the second driver 220 to transfer the generated output signals to the corresponding switching unit 300.

A configuration and an operation of the switching unit 300 which receives the output signal transferred from the signal generator to generate the scan signal to be transferred to the first group pixel or the second group pixel will be described below.

FIG. 12 illustrates a circuit diagram for a switching unit 300 included in one stage of the scan driver 20 shown in FIG. 4.

In the scan driver according to the exemplary embodiment, the switching unit 300 is a unit which selectively generates and transfers scan signals transferred to the first group pixels and the second group pixels among a plurality of pixels of a display unit.

The switching unit 300 includes an output signal input terminal OUT_G, a first selection signal input terminal SEL_1F, a second selection signal input terminal SEL_2F, a first scan signal output terminal 1FS, a second scan signal output terminal 2FS, and a plurality of transistors M31, M32, M33, and M34.

An output signal generated and transferred in the signal generator 200 connected to the switching unit 300 is input to the output signal input terminal OUT_G.

The first selection signal controlling the transferred output signal to be outputted as a scan signal (hereinafter, referred to as a first scan signal) activating the plurality of pixels included in the first group pixel of the display unit is inputted to the first selection signal input terminal SEL_1F.

The second selection signal controlling the transferred output signal to be outputted as a scan signal (hereinafter, referred to as a second scan signal) activating the plurality of pixels included in the second group pixel of the display unit is input to the second selection signal input terminal SEL_2F.

The first scan signal is output to the pixel of the first group pixel through the first scan signal output terminal 1FS. Further, the second scan signal is output to the pixel of the second group pixel through the second scan signal output terminal 2FS.

The first transistor M31 includes a gate electrode connected to the first selection signal input terminal SEL_1F, one terminal connected to the output signal input terminal OUT_G, and the other terminal connected to the first scan signal output terminal 1FS.

The second transistor M32 includes a gate electrode connected to the second selection signal input terminal SEL_2F, one terminal connected to the output signal input terminal OUT_G, and the other terminal connected to the second scan signal output terminal 2FS.

The third transistor M33 includes a gate electrode connected to the second selection signal input terminal SEL_2F, one terminal connected to a VGH power source, and the other terminal connected to the first scan signal output terminal 1FS.

The fourth transistor M34 includes a gate electrode connected to the first selection signal input terminal SEL_1F, one terminal connected to the VGH power source, and the other terminal connected to the second scan signal output terminal 2FS.

Herein, the VGH power source is a power source having high-level voltage (for example, a state having a logic value of 1).

The plurality of transistors M31, M32, M33, and M34 may be p-channel field effect transistors or n-channel field effect transistors and are not particularly limited thereto

Further, various kinds of TFTs such as a polysilicon thin film transistor (poly-Si TFT), an oxide thin film transistor (Oxide TFT), an amorphous silicon thin film transistor (a-Si TFT), and the like may be used.

Since the transistor configured by PMOS is exemplified in FIG. 12, gate-on voltage tuning on the plurality of transistors M31, M32, M33, and M34 is low-level voltage and gate-off voltage turning off the plurality of transistors M31, M32, M33, and M34 is high-level voltage.

When the output signal transferred from the signal generator 200 through the input terminal OUT_G is applied at the low-level voltage and the low-level voltage is applied through the first selection signal input terminal SEL_1F, the gate-on voltage is transferred to the first transistor M31 and the fourth transistor M34 to be turned on. The first scan signal of the low-level voltage activating the first group pixel is output to the first scan signal output terminal 1FS through the turned-on transistor M31. In this case, the first scan signal is outputted at the low-level voltage of the output signal transferred through the input terminal OUT_G.

Further, the fourth transistor M34 is turned on and thus, VGH voltage connected to one terminal of the fourth transistor M34 is transferred through the second selection signal input terminal SEL_2F. Therefore, while the first scan signal is transferred to each of the first group pixels to be activated (for the scan period 3 of the first field), the second scan signal transferred to each of the second group pixels is transferred at the high-level voltage not to drive the second group pixel.

While the low-level voltage is applied through the first selection signal input terminal SEL_1F, the high-level voltage is applied through the second selection signal input terminal SEL_2F, such that the second transistor M32 and the third transistor M33 are turned off not to influence the driving of the switching unit 300.

Meanwhile, when the output signal transferred from the signal generator 200 through the input terminal OUT_G is applied at the low-level voltage and the low-level voltage is applied through the second selection signal input terminal SEL_2F, the gate-on voltage is transferred to the second transistor M32 and the third transistor M33 to be turned on. The second scan signal of the low-level voltage activating the second group pixel is output to the second scan signal output terminal 2FS through the turned-on second transistor M32. In this case, the second scan signal is outputted at the low-level voltage of the output signal transferred through the input terminal OUT_G.

Further, the third transistor M33 is turned on and thus, the VGH voltage connected to one terminal of the third transistor M33 is transferred through the first selection signal input terminal SEL_1F. Therefore, while the second scan signal is transferred to each of the second group pixels to be activated (for the scan period 3 of the second field), the first scan signal transferred to each of the first group pixels is transferred at the high-level voltage not to drive the first group pixel.

While the low-level voltage is applied through the second selection signal input terminal SEL_2F, the high-level voltage is applied through the first selection signal input terminal SEL_1F, such that the first transistor M31 and the fourth transistor M34 are turned off not to influence the driving of the switching unit 300.

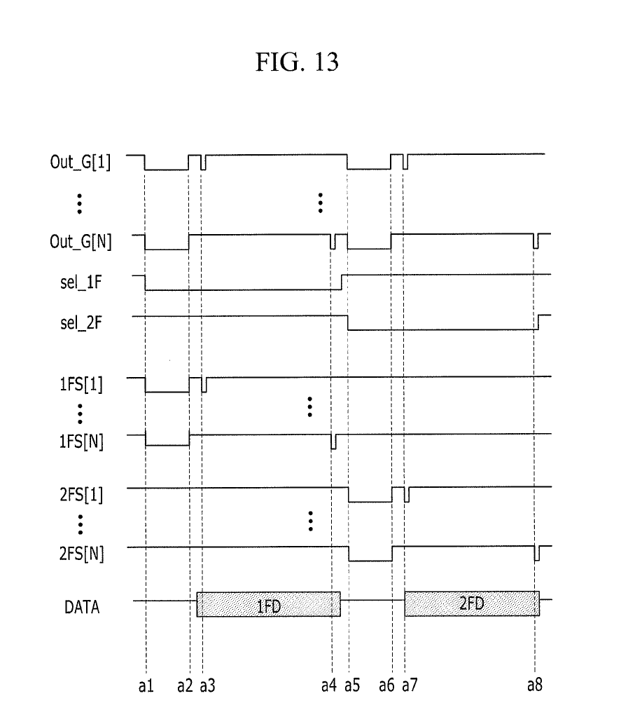

FIG. 13 illustrates a timing diagram of a driving of the switching unit 300 of FIG. 12.

First, in a section a1 to a2, all the output signals Out_G[1] to Out_G[N] transferred through the input terminal OUT_G are applied at the low-level voltage. For the section, since the first selection signal sel_1F is in a low state and the second selection signal sel_2F is in a high state, as shown in FIG. 12, the output signals Out_G[1] to Out_G[N] are outputted as the first scan signals 1FS[1] to 1FS[N] transferred to the first group pixel of the display unit. The section a1 to a2 is a period for which the reset of the gate voltage of the driving transistor of the first group pixel and the compensation of threshold voltage are performed and referring to FIG. 1, the scan signal is transferred at the low-level voltage for the reset period 1 and the compensation period 2 of the first field.

Next, for a section a3 to a4, the output signals Out_G[1] to Out_G[N] transferred through the input terminal OUT_G are sequentially applied at the low-level voltage one by one. Similarly, even for the section, since the first selection signal sel_1F is in a low state and the second selection signal sel_2F is in a high state, the first scan signals 1FS[1] to 1FS[N] transferred to the first group pixel are sequentially outputted at the low-level voltage one by one in response to the output signals Out_G[1] to Out_G[N] transferred at the low-level voltage in sequence. Accordingly, the section as the scan period 3 of the first field becomes a data writing section 1FD in which each of the first group pixels is sequentially activated in response to the first scan signals 1FS[1] to 1FS[N] transferred at the low-level voltage and thus, the video data signal is transferred and stored.

Meanwhile, in a section a5 to a6, all the output signals Out_G[1] to Out_G[N] transferred through the input terminal OUT_G are applied at the low-level voltage again. For the section, since the second selection signal sel_2F is in a low state and the first selection signal sel_1F is in a high state, as shown in FIG. 12, the output signals Out_G[1] to Out_G[N] are outputted as the second scan signals 2FS[1] to 2FS[N] transferred to the second group pixel of the display unit. That is, the section a5 to a6 is a period for which the reset of the gate voltage of the driving transistor of the second group pixel and the compensation of threshold voltage are performed and referring to FIG. 1, the scan signal is transferred at the low-level voltage for the reset period 1 and the compensation period 2 of the second field.

Then, for a section a7 to a8, the output signals Out_G[1] to Out_G[N] transferred through the input terminal OUT_G are sequentially applied at the low-level voltage one by one. Similarly, even for the section, since the second selection signal sel_2F is in a low state and the first selection signal sel_1F is in a high state, the second scan signals 2FS[1] to 2FS[N] transferred to the second group pixels are sequentially outputted at the low-level voltage one by one in response to the output signals Out_G[1] to Out_G[N] transferred at the low-level voltage in sequence. Accordingly, the section as the scan period 3 of the second field becomes a data writing section 2FD in which each of the second group pixels is sequentially activated in response to the second scan signals 2FS[1] to 2FS[N] transferred at the low-level voltage and thus, the video data signal is transferred and stored.

Like the sections a1 to a2 and a5 to a6, in order to output all the output signals Out_G[1] to Out_G[N] at the low-level voltage at the same time, as described above, the second driver 220 of the signal generator 200 operates to transfer the simultaneous output signals to the switching unit 300. Meanwhile, like the sections a3 to a4 and a7 to a8, in order to output the output signals Out_G[1] to Out_G[N] at the low-level voltage in sequence, the first driver 210 of the signal generator 200 operates to transfer the sequential output signals to the switching unit 300.

Referring to FIG. 13, the switching unit 300 receives the output signals having the same waveform to generate the first scan signals applied to the first group pixels or generate the second scan signals applied to the second group pixels according to the driving control of the first selection signal sel_1F and the second selection signal sel_2F. According to the scan driver of one or more embodiments, the scan signal generated and transferred for each pixel group may be implemented by an embedded circuit having the number of stages as many as at least the number of the pixel rows, such that the scan driver of the present invention may be simplified and an area capacity thereof may be largely reduced as compared with the scan driver in the related art.

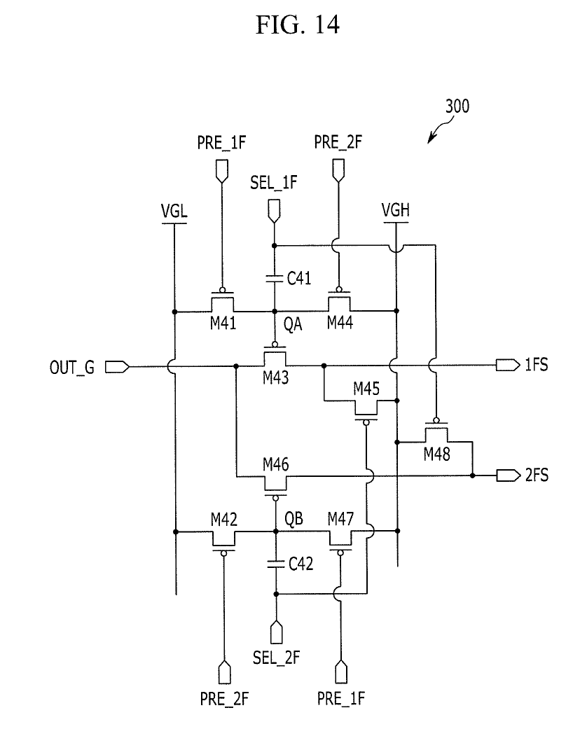

FIG. 14 illustrates a circuit diagram for a switching unit according to another exemplary embodiment of the scan driver shown in FIG. 4.

Referring to FIG. 14, the switching unit 300 of the scan driver includes an output signal input terminal OUT_G, a first selection signal input terminal SEL_1F, a second selection signal input terminal SEL_2F, a first control signal input terminal PRE_1F, a second control signal input terminal PRE_2F, a first scan signal output terminal IFS, a second scan signal output terminal 2FS, a plurality of transistors M41, M42, M43, M44, M45, M46, M47, and M48, a first capacitor C41, and a second capacitor C42.

An output signal generated and transferred from the signal generator 200 connected to the switching unit 300 is inputted to the output signal input terminal OUT_G.

A first selection signal, which controls the transferred output signal to be outputted as the first scan signal activating the plurality of pixels included in the first group pixel of the display unit, is inputted to the first selection signal input terminal SEL_1F.

A second selection signal, which controls the transferred output signal to be outputted as the second scan signal activating the plurality of pixels included in the second group pixel of the display unit, is inputted to the second selection signal input terminal SEL_2F.

The first scan signal is outputted to the first group pixel through the first scan signal output terminal 1FS. Further, the second scan signal is outputted to the second group pixel through the second scan signal output terminal 2FS.

The first control signal more exactly performing the on/off operation of the transistor is input to the first control signal input terminal PRE_1F so that a signal inputted to the switching unit according to the driving operation of the switching unit 300 may be selectively outputted as the first scan signal or the second scan signal. The second control signal more exactly performing the on/off operation of the transistor is inputted to the second control signal input terminal PRE_2F so that a signal inputted to the switching unit according to the driving operation of the switching unit 300 may be selectively outputted as the first scan signal or the second scan signal.

The plurality of transistors M41, M42, M43, M44, M45, M46, M47, and M48 may be p-channel field effect transistors or n-channel field effect transistors and are not particularly limited thereto. Further, various kinds of TFTs such as a polysilicon thin film transistor (poly-Si TFT), an oxide thin film transistor (Oxide TFT), an amorphous silicon thin film transistor (a-Si TFT), and the like may be used.

The first transistor M41 includes a gate electrode connected to the first control signal input terminal PRE_1F, one terminal connected to a VGL power source, and the other terminal connected to a QA node.

The second transistor M42 includes a gate electrode connected to the second control signal input terminal PRE_2F, one terminal connected to the VGL power source, and the other terminal connected to a QB node.

The third transistor M43 includes a gate electrode connected to the QA node connected with the first selection signal input terminal SEL_1F, one terminal connected to the input terminal OUT_G of the output signal, and the other terminal connected to the first scan signal output terminal 1FS.

The fourth transistor M44 includes a gate electrode connected to the second control signal input terminal PRE_2F, one terminal connected to a VGH power source, and the other terminal connected to the QA node.

The fifth transistor M45 includes a gate electrode connected to the second selection signal input terminal SEL_2F, one terminal connected to the VGH power source, and the other terminal connected to the first scan signal output terminal IFS.

The sixth transistor M46 includes a gate electrode connected to the QB node connected with the second selection signal input terminal SEL_2F, one terminal connected to the input terminal OUT_G of the output signal, and the other terminal connected to the second scan signal output terminal 2FS.

The seventh transistor M47 includes a gate electrode connected to the first control signal input terminal PRE_1F, one terminal connected to the VGH power source, and the other terminal connected to the QB node.

The eighth transistor M48 includes a gate electrode connected to the first selection signal input terminal SEL_1F, one terminal connected to the VGH power source, and the other terminal connected to the second scan signal output terminal 2FS.

The first capacitor C41 includes one electrode connected to the first selection signal input terminal SEL_1F and the other electrode connected to the QA node.

The second capacitor C42 includes one electrode connected to the second selection signal input terminal SEL_2F and the other electrode connected to the QB node.

Herein, the VGH power source is a power source having high-level voltage (for example, a state having a logic value of 1). The VGL power source is a power source having low-level voltage (for example, a state having a logic value of 0).

When the voltages inputted to the output signal input terminal OUT_G, the first selection signal input terminal SEL_1F, the second selection signal input terminal SEL_2F, the first control signal input terminal PRE_1F, and the second control signal input terminal PRE_2F are in the high level state, if the first control signal inputted to the first control signal input terminal PRE_1F is applied at the low-level voltage, the first transistor M41 and the seventh transistor M47 are turned on. The low-level VGL power source voltage is transferred to the QA node through the first transistor M41. The high-level VGH power source voltage is transferred to the QB node through the seventh transistor M47. As a result, the third transistor M43 connected to the QA node is turned on and the sixth transistor M46 connected to the QB node is turned off. In this case, the first capacitor C41 connected to the QA node stores the voltage corresponding to a difference between the voltages applied to both electrodes. Similarly, the second capacitor C42 connected to the QB node also stores the voltage applied to both the electrodes. The first scan signal may be controlled so as to be selectively generated and outputted to the first scan signal output terminal 1FS by more exactly performing the turning-on of the third transistor M43 and the turning-off of the sixth transistor M46. In this case, the scan signal may be controlled so as not to be outputted to the second scan signal output terminal 2FS.

When the output signal transferred from the signal generator 200 through the input terminal OUT_G is applied at the low-level voltage and the low-level voltage is applied through the first selection signal input terminal SEL_1F, the voltage transferred to the gate electrode of the third transistor M43 sufficiently drops by the bootstrap of the first capacitor C41 and thus, the third transistor M43 is completely turned on. Then, the first scan signal of the low-level voltage activating the first group pixel is outputted to the first scan signal output terminal 1FS through the third transistor M43. In this case, the first scan signal is outputted at the low-level voltage of the output signal transferred through the input terminal OUT_G.

In this case, the eighth transistor M48 receiving the low-level voltage through the first selection signal input terminal SEL_1F is also turned on and as a result, the high-level VGH voltage is transferred to the second scan signal output terminal 2FS. Then, while the first scan signal is transferred to each of the first group pixels to be activated (for the scan period 3 of the first field), the second scan signal transferred to each of the second group pixels is transferred at the high-level voltage so as not to drive the second group pixel.

While the low-level voltage is applied through the first selection signal input terminal SEL_1F, the high-level voltage is applied through the second selection signal input terminal SEL_2F, the first control signal input terminal PRE_1F, and the second control signal input terminal PRE_2F, such that the rest transistors except for the third transistor M43 and the eighth transistor M48 are turned off so as not to influence the driving of the switching unit 300.

Meanwhile, when the output signal transferred from the signal generator 200 through the input terminal OUT_G is applied at the low-level voltage and the low-level voltage is applied through the second selection signal input terminal SEL_2F, the voltage transferred to the gate electrode of the sixth transistor M46 sufficiently drops by the bootstrap of the second capacitor C42 and thus, the sixth transistor M46 is completely turned on. Then, the second scan signal of the low-level voltage activating the second group pixel is outputted to the second scan signal output terminal 2FS through the sixth transistor M46. In this case, the second scan signal is outputted at the low-level voltage of the output signal transferred through the input terminal OUT_G.

In this case, the fifth transistor M45 receiving the low-level voltage through the second selection signal input terminal SEL_2F is also turned on and as a result, the high-level VGH voltage is transferred to the first scan signal output terminal 1FS. Then, while the second scan signal is transferred to each of the second group pixels to be activated (for the scan period 3 of the second field), the first scan signal transferred to each of the first group pixel is transferred at the high-level voltage so as not to drive the first group pixel.

While the low-level voltage is applied through the second selection signal input terminal SEL_2F, the high-level voltage is applied through the first selection signal input terminal SEL_1F, the first control signal input terminal PRE_1F, and the second control signal input terminal PRE_2F, such that the rest transistors except for the sixth transistor M46 and the fifth transistor M45 are turned off so as not to influence the driving of the switching unit 300.

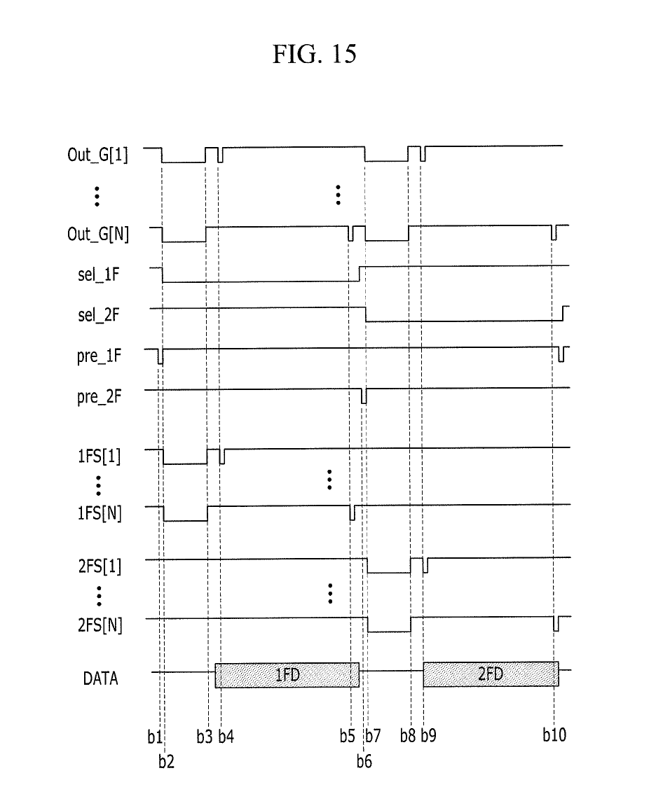

FIG. 15 illustrates a timing diagram for driving of the switching unit 300 of FIG. 14.

First, in a section b1 to b2, in the state where signals inputted to the output signal input terminal OUT_G, the first selection signal input terminal SEL_1F, the second selection signal input terminal SEL_2F, and the second control signal input terminal PRE_2F are the high-level voltage, a first control signal pre_1F inputted to the first control signal input terminal PRE_1F is applied at the low-level voltage. As described in FIG. 14, as a result, the turning-on of the third transistor M43 and the turning-off of the sixth transistor M46 are more exactly performed.

Next, in a section b2 to b3, all the output signals Out_G[1] to Out_G[N] transferred through the input terminal OUT_G are applied at the low-level voltage. For the section, since the first selection signal sel_1F is in a low state and the second selection signal sel_2F is in a high state, as shown in FIG. 14, the output signals Out_G[1] to Out_G[N] are outputted as the first scan signals 1FS[1] to 1FS[N] transferred to the first group pixel of the display unit. The section b2 to b3 is the reset period 1 and the compensation period 2 of the first field in which the reset of the gate voltage of the driving transistor of the first group pixel and the compensation of threshold voltage are performed and for the section, the scan signal is transferred at the low-level voltage.

Next, for a section b4 to b5, the output signals Out_G[1] to Out_G[N] transferred through the input terminal OUT_G are sequentially applied at the low-level voltage one by one. Similarly, even for the section, since the first selection signal sel_1F is in a low state and the second selection signal sel_2F is in a high state, the first scan signals 1FS[1] to 1FS[N] transferred to the first group pixel are sequentially outputted at the low-level voltage one by one in response to the output signals Out_G[1] to Out_G[N] transferred at the low-level voltage in sequence. Accordingly, the section as the scan period 3 of the first field becomes a data writing section 1FD in which each of the first group pixels is sequentially activated in response to the first scan signals 1FS[1] to 1FS[N] transferred at the low-level voltage and thus, the video data signal is transferred and stored.

Meanwhile, in a section b6 to b7, a second control signal pre_2F input to the second control signal input terminal PRE_2F is applied at the low-level voltage. As described in FIG. 14, as a result, the turning-off of the third transistor M43 and the turning-on of the sixth transistor M46 are more exactly performed.

In addition, in a section b7 to b8, all the output signals Out_G[1] to Out_G[N] transferred through the input terminal OUT_G are applied at the low-level voltage again. For the section, since the second selection signal sel_2F is in a low state and the first selection signal sel_1F is in a high state, as shown in FIG. 14, the output signals Out_G[1] to Out_G[N] are outputted as the second scan signals 2FS[1] to 2FS[N] transferred to the second group pixel of the display unit. That is, the section b7 to b8 is the reset period 1 and the compensation period 2 of the second field in which the reset of the gate voltage of the driving transistor of the second group pixel and the compensation of threshold voltage are performed and for the section, the scan signal is transferred at the low-level voltage.

In addition, for a section b9 to b10, the output signals Out_G[1] to Out_G[N] transferred through the input terminal OUT_G are sequentially applied at the low-level voltage one by one. Similarly, even for the section, since the second selection signal sel_2F is in a low state and the first selection signal sell F is in a high state, the second scan signals 2FS[1] to 2FS[N] transferred to the second group pixel are sequentially outputted at the low-level voltage one by one in response to the output signals Out_G[1] to Out_G[N] transferred at the low-level voltage in sequence. Accordingly, the section as the scan period 3 of the second field becomes a data writing section 2FD in which each of the second group pixels is sequentially activated in response to the second scan signals 2FS[1] to 2FS[N] transferred at the low-level voltage and thus, the video data signal is transferred and stored.

The scan driver according to the exemplary embodiment of the present invention of FIGS. 14 and 15 also may simplify a configuration of the circuit stage and perform the generation and the output of the first scan signal applied to the first group pixel and the second scan signal applied to the second group pixel according to the driving control of the selection signal, respectively. Further, unlike the exemplary embodiment of FIGS. 12 and 13, the switching operation of the configuration circuit element according to the control signal before the generation and the output of the scan signal is more exactly performed, thereby increasing reliability of the control of the scan driving.

The drawings and the detailed description described above are examples of the inventive concept and are provided to explain the inventive concept and the scope of claims is not limited thereto. Therefore, it is understood that various modifications and other equivalent exemplary embodiments may be possible by those who are skilled in the art. Those skilled in the art can omit some of the constituent elements described in the present specification without deterioration in performance thereof or can add constituent elements to improve performance thereof. Further, those skilled in the art can modify the sequence of the steps of the method described in the present specification depending on the process environment or equipment. Therefore, the range of the present invention must be determined by the scope of the claims and the equivalent, not by the described exemplary embodiments.

<Description of symbols>

| | |
|---|---|
| 10: Display unit | 20: Scan driver |
| 30: Data driver | 40: Power source controller |
| 50: Signal controller | 60: Pixel |
| 110, 111, 112, 113: Stage | 200: Signal generator |
| 210: First driver | 220: Second driver |
| 300: Switching unit | |

What is claimed is:

1. A scan driver, comprising:
a signal generator configured to generate and output a plurality of first signals to a plurality of output lines sequentially and/or to generate and output a plurality of second signals to the plurality of output simultaneously; and
a switching unit configured to receive the plurality of first signals or the plurality of second signals from the signal generator and to select a plurality of first scan lines connected to first group pixels among a plurality of pixels included in a display unit or a plurality of second scan lines connected to second group pixels different from the first group pixels among the plurality of pixels to output the plurality of first signals or the plurality of second signals as corresponding scan signals.

2. The scan driver of claim 1, wherein:
the switching unit receives a first selection signal selecting the plurality of first scan lines and a second selection signal selecting the plurality of second scan lines to control the output of the plurality of first signals or the plurality of second signals input to the switching unit.

3. The scan driver of claim 2, wherein:
each of the first selection signal and the second selection signal are transferred with a predetermined period and with different voltage polarities.

4. The scan driver of claim 2, wherein the switching unit includes:
a signal input terminal to which the plurality of first signals or the plurality of second signals are transferred,
a first selection signal input terminal to which the first selection signal is transferred,
a second selection signal input terminal to which the second selection signal is transferred,
a first output terminal connected to the plurality of first scan lines to output the plurality of first signals or the plurality of second signals as a plurality of first scan signals, and
a second output terminal connected to the plurality of second scan lines to output the plurality of first signals or the plurality of second signals as a plurality of second scan signals.

5. The scan driver of claim 4, wherein the switching unit includes:
a first transistor configured to be turned on by the first selection signal to transfer a voltage depending on the plurality of first signals or the plurality of second signals applied to the signal input terminal to the first output terminal,
a second transistor configured to be turned on by the second selection signal to transfer the voltage depending on the plurality of first signals or the plurality of second signals applied to the signal input terminal to the second output terminal,
a third transistor configured to be turned on by the second selection signal to transfer the voltage to the first output terminal, and
a fourth transistor configured to be turned on by the first selection signal to transfer the voltage to the second output terminal.

6. The scan driver of claim 5, wherein:
the first to the fourth transistors and a plurality of transistors included in a plurality of pixels receiving scan signals output through the first output terminal and the second output terminal are p-channel field effect transistors, and
the voltage is a high-level voltage that is greater than a voltage for turning off the p-channel field effect transistor.

7. The scan driver of claim 5, wherein:
the first transistor and the fourth transistor are turned on and the second transistor and the third transistor are turned off for a period while the voltage depending on the plurality of first signals or the plurality of second signals is transferred to the first output terminal, and
the second transistor and the third transistor are turned on and the first transistor and the fourth transistor are turned off for a period while the voltage depending on the plurality of first signals or the plurality of second signals is transferred to the second output terminal.

8. The scan driver of claim 4, wherein the switching unit further includes:
a first control signal input terminal to which a first control signal induces turning-on of a first switch transferring the plurality of first signals or the plurality of second signals to the first output terminal in advance is transferred before the first selection signal is transferred, and
a second control signal input terminal to which a second control signal induces turning-on of a second switch transferring the plurality of first signals or the plurality of second signals to the second output terminal in advance is transferred before the second selection signal is transferred.

9. The scan driver of claim 8, wherein the switching unit includes:
a first transistor configured to be turned on by the first control signal to transfer second voltage to a first node,
a second transistor configured to be turned on by the second control signal to transfer the second voltage to a second node,
a third transistor configured to be turned on according to a voltage level applied to the first node to transfer voltage depending on the plurality of first signals or the plurality of second signals applied to the signal input terminal to the first output terminal,
a fourth transistor configured to be turned on according to a voltage level applied to the second node to transfer voltage depending on the plurality of first signals or the plurality of second signals applied to the signal input terminal to the second output terminal,
a fifth transistor configured to be turned on by the second control signal to transfer third voltage to the first node,
a sixth transistor turned on by the first control signal to transfer the third voltage to the second node,
a seventh transistor configured to be turned on by the first selection signal to transfer the third voltage to the second output terminal,
an eighth transistor configured to be turned on by the second selection signal to transfer the third voltage to the first output terminal,
a first capacitor including a first electrode connected to the first node and a second electrode connected to a first selection signal input terminal to which the first selection signal is transferred, and
a second capacitor including a first electrode connected to the second node and a second electrode connected to a second selection signal input terminal to which the second selection signal is transferred.

10. The scan driver of claim 9, wherein:
the first to the eighth transistors and a plurality of transistors included in a plurality of pixels receiving scan signals output through the first output terminal and the second output terminal are p-channel field effect transistors and
the second voltage is low-level voltage of less than voltage turning on the p-channel field effect transistor and the third voltage is high-level voltage of more than voltage turning off the p-channel field effect transistor.

11. The scan driver of claim 9, wherein:
the first transistor, the third transistor, and the sixth transistor are turned on for a period while the first control signal is transferred at a gate-on voltage level of the first to the eighth transistors, and
the second transistor, the fourth transistor, and the fifth transistor are turned on for a period while the second control signal is transferred at a gate-on voltage level of the first to the eighth transistors.

12. The scan driver of claim 9, wherein:
the third transistor and the seventh transistor are turned on and the fourth transistor and the eighth transistor are turned off for a period while the voltage according to the plurality of first signals or the plurality of second signals is transferred to the first output terminal, and
the fourth transistor and the eighth transistor are turned on and the third transistor and the seventh transistor are turned off for a period while the voltage according to the plurality of first signals or the plurality of second signals is transferred to the second output terminal.

13. The scan driver of claim 1, wherein the signal generator includes:
a first driver connected to the plurality of output lines and a second driver connected to the plurality of output lines, and
when any one of the first driver and the second driver is in a scan enable state where the plurality of first signals or the plurality of second signals are applied to the plurality of output lines, another one of the first and second drivers is in a floating state where an output terminal is floated.

14. The scan driver of claim 13, wherein:
the first driver generates and transfers the plurality of first signals to the plurality of output lines sequentially, and
the second driver generates and transfers the plurality of second signals to the plurality of output lines simultaneously.

15. The scan driver of claim 14, wherein:
after the first driver transfers the plurality of first signals to the plurality of output lines in sequence and an output terminal of the first driver is floated, the second driver transfers the plurality of second signals to the plurality of output lines at the same time.

16. The scan driver of claim 14, wherein:
after the second driver transfers the plurality of second signals to the plurality of output lines at the same time and an output terminal of the second driver is floated, the first driver transfers the plurality of first signals to the plurality of output lines in sequence.

17. The scan driver of claim 13, wherein:
the first driver includes a plurality of first output driving blocks connected to the plurality of output lines, respectively, and
the first output driving block includes:
an output terminal connected to the corresponding output line,
a first transistor transferring a high-level voltage to the output terminal,
a second transistor transferring a low-level voltage to the output terminal, and
wherein a voltage configured to turn off each of the first transistor and the second transistor is transferred to gate electrodes of the first transistor and the second transistor according to a floating signal during a floating state of the output terminal.

18. The scan driver of claim 17, wherein the first output driving block further includes:
a floating signal input terminal to which the floating signal is input,
a third transistor transferring the voltage turning off the first transistor to the gate electrode of the first transistor depending on the floating signal, and
a fourth transistor transferring the voltage turning off the second transistor to the gate electrode of the second transistor depending on the floating signal.

19. The scan driver of claim 18, wherein:
the third transistor includes a gate electrode connected to the floating signal input terminal, a first terminal connected to a power source having the high-level voltage, and a second terminal connected to the gate electrode of the first transistor.

20. The scan driver of claim 18, wherein:
the fourth transistor includes a gate electrode connected to the floating signal input terminal, a first terminal connected to a power source having the high-level voltage, and a second terminal connected to the gate electrode of the second transistor.

21. The scan driver of claim 17, wherein the plurality of first output driving blocks include:
a first stage synchronized with a second clock signal to output a third clock signal to a first output terminal according to an input signal and output the high-level voltage to the first output terminal according to a first clock signal,
a second stage synchronized with the third clock signal to output the first clock signal to a second output terminal according to an output signal of the first stage and output the high-level voltage to the second output terminal according to the second clock signal, and
a third stage synchronized with the first clock signal to output the second clock signal to a third output terminal according to an output signal of the second stage and output the high-level voltage to the third output terminal according to the third clock signal, and
the first to third output terminals are floated with the first to third stages according to the floating signal.

22. The scan driver of claim 21, wherein:
the second clock signal is a signal in which the first clock signal is shifted by a duty of the first clock signal and the third clock signal is a signal in which the second clock signal is shifted by a duty of the second clock signal.

23. The scan driver of claim 21, wherein:
the plurality of first output driving blocks are formed by repeating the first to third stages.

24. The scan driver of claim 21, wherein the first stage includes:
a first transistor configured to be turned on by low-level voltage transferred according to the first clock signal to transfer the high-level voltage to the first output terminal,
a second transistor configured to be turned on by the input signal transferred according to the second clock signal to transfer the third clock signal to the first output terminal,
a third transistor configured to transfer the high-level voltage to the gate electrode of the first transistor according to the floating signal to turn off the first transistor, and
a fourth transistor configured to transfer the high-level voltage to the gate electrode of the second transistor according to the floating signal to turn off the second transistor.

25. The scan driver of claim 21, wherein the second stage includes:
a first transistor configured to be turned on by low-level voltage transferred according to the second clock signal to transfer the high-level voltage to the second output terminal,
a second transistor configured to be turned on by the input signal transferred according to the third clock signal to transfer the first clock signal to the second output terminal,
a third transistor configured to transfer the high-level voltage to the gate electrode of the first transistor according to the floating signal to turn off the first transistor, and
a fourth transistor configured to transfer the high-level voltage to the gate electrode of the second transistor according to the floating signal to turn off the second transistor.

26. The scan driver of claim 21, wherein the third stage includes:
a first transistor configured to be turned on by low-level voltage transferred according to the third clock signal to transfer the high-level voltage to the third output terminal,
a second transistor configured to be turned on by the input signal transferred according to the first clock signal to transfer the second clock signal to the third output terminal,
a third transistor configured to transfer the high-level voltage to the gate electrode of the first transistor according to the floating signal to turn off the first transistor, and
a fourth transistor configured to transfer the high-level voltage to the gate electrode of the second transistor according to the floating signal to turn off the second transistor.

27. The scan driver of claim 13, wherein:
the second driver includes a plurality of second output driving blocks connected to the plurality of output lines, respectively,
the second output driving block includes:
an output terminal connected to the corresponding output line,
a first transistor transferring high-level voltage to the output terminal, and
a second transistor transferring low-level voltage to the output terminal,
wherein a voltage turning off each of the first transistor and the second transistor is transferred to gate electrodes of the first transistor and the second transistor according to a floating signal during a floating state of the output terminal.

28. The scan driver of claim 27, wherein the second output driving block further includes:
a floating signal input terminal to which the floating signal is input,
a third transistor transferring voltage turning off the first transistor to the gate electrode of the first transistor depending on the floating signal, and
a fourth transistor transferring voltage turning off the second transistor to the gate electrode of the second transistor depending on the floating signal.

29. The scan driver of claim 28, wherein:
the third transistor includes a gate electrode connected to the floating signal input terminal, a first terminal connected to a power source having the high-level voltage, and a second terminal connected to the gate electrode of the first transistor.

30. The scan driver of claim 28, wherein:
the fourth transistor includes a gate electrode connected to the floating signal input terminal, one terminal connected to a power source having the high-level voltage, and the other terminal connected to the gate electrode of the second transistor.

31. The scan driver of claim 28, wherein the second output driving block further includes:
a first control signal input terminal to which the first control signal is input,
a second control signal input terminal to which the second control signal is inputted,
a fifth transistor configured to transfer the voltage turning off the first transistor to the gate electrode of the first transistor depending on the first control signal,
a sixth transistor configured to transfer the voltage turning on the second transistor to the gate electrode of the second transistor depending on the first control signal to transfer the low-level voltage to the output terminal through the second transistor,
a seventh transistor configured to transfer the voltage turning off the second transistor to the gate electrode of the second transistor depending on the second control signal, and
an eighth transistor configured to transfer the voltage turning on the first transistor to the gate electrode of the first transistor depending on the second control signal to transfer the high-level voltage to the output terminal through the first transistor.

32. The scan driver of claim 31, wherein:
the fifth transistor includes a gate electrode connected to the first control signal input terminal, one terminal connected to a power source having the high-level voltage, and the other terminal connected to the gate electrode of the first transistor.

33. The scan driver of claim 31, wherein:
the sixth transistor includes a gate electrode connected to the first control signal input terminal, a first terminal connected to a power source having the low-level voltage, and a second terminal connected to the gate electrode of the second transistor.

34. The scan driver of claim 31, wherein:
the seventh transistor includes a gate electrode connected to the second control signal input terminal, a first terminal connected to a power source having the high-level voltage, and a second terminal connected to the gate electrode of the second transistor.

35. The scan driver of claim 31, wherein:
the eighth transistor includes a gate electrode connected to the second control signal input terminal, a first terminal connected to a power source having the low-level voltage, and a second terminal connected to the gate electrode of the first transistor.

36. The scan driver of claim 27, wherein the plurality of second output driving blocks include:
at least one stage synchronized with the first control signal applied at a gate-on level voltage of the second transistor to output the low-level voltage to the output terminal and synchronized with the second control signal applied at the gate-on level voltage of the first transistor to output the high-level voltage to the output terminal, and
wherein, in the output terminal, at least one stage is floated according to the floating signal.

37. The scan driver of claim 36, wherein:
the at least one stage simultaneously transfers the output signals to the plurality of output lines according to the first control signal and the second control signal.

38. A display device, comprising:
a display unit including a first group pixel configured by a plurality of pixels and a second group pixel different from the first group pixel and configured by a plurality of pixels;
a data driver configured to transfer data signals to a plurality of data lines connected to the display unit; and
a scan driver configured to transfer scan signals to a plurality of first scan lines connected to the first group pixel or a plurality of second scan lines connected to the second group pixel so that the data signals are transferred to the display unit,
wherein the scan driver includes a signal generator and a switching unit connected with each other through a plurality of output lines,
the signal generator is configured to generate and output a plurality of first signals to the plurality of output lines sequentially and/or to generate and output a plurality of second signals simultaneously, and
the switching unit is configured to receive the plurality of first signals or the plurality of second signals to select the plurality of first scan lines or the plurality of second scan lines and output the plurality of first signals or the plurality of second signals as the scan signals.

39. The display device of claim 38, wherein:
the switching unit is configured to receive a first selection signal selecting the plurality of first scan lines and a second selection signal selecting the plurality of second scan lines to control the output of the plurality of first signals or the plurality of second signals inputted to the switching unit.

40. The display device of claim 39, wherein:
the first selection signal and the second selection signal are transferred with a predetermined period with different voltage polarities.

41. The display device of claim 39, wherein the switching unit includes:
a signal input terminal to which the plurality of first signals or the plurality of second signals are transferred,
a first selection signal input terminal to which the first selection signal is transferred, a second selection signal input terminal to which the second selection signal is transferred,
a first output terminal connected to the plurality of first scan lines to output the plurality of first signals or the plurality of second signals as a plurality of first scan signals, and
a second output terminal connected to the plurality of second scan lines to output the plurality of first signals or the plurality of second signals as a plurality of second scan signals.

42. The display device of claim 41, wherein the switching unit further includes:
a first control signal input terminal to which a first control signal inducing turning-on of a first switch transferring the plurality of first signals or the plurality of second signals to the first output terminal in advance is transferred before the first selection signal is transferred, and
a second control signal input terminal to which a second control signal inducing turning-on of a second switch transferring the plurality of first signals or the plurality of second signals to the second output terminal in advance is transferred before the second selection signal is transferred.

43. The display device of claim 38, wherein the signal generator includes:
a first driver connected to the plurality of output lines and a second driver connected to the plurality of output lines, and
wherein, when any one of the first driver and the second driver is in a scan enable state during which the plurality of first signals or the plurality of second signals are applied to the plurality of output lines, another of the first and the second driver is in a floating state during which an output terminal thereof is floated.

44. The display device of claim 43, wherein:
the first driver generates and transfers the plurality of first signals to the plurality of output lines sequentially, and
the second driver generates and transfers the plurality of second signals to the plurality of output lines simultaneously.

45. The display device of claim 44, wherein:
after the first driver transfers the plurality of first signals to the plurality of output lines sequentially and the output terminal of the first driver is floated, the second driver transfers the plurality of second signals to the plurality of output lines simultaneously.

46. The display device of claim 44, wherein:
after the second driver transfers the plurality of second signals to the plurality of output lines simultaneously and the output terminal of the second driver is floated, the first driver transfers the plurality of first signals to the plurality of output lines sequentially.

47. A driving method of a scan driver, including a signal generator and a switching unit connected with each other through a plurality of output lines and transferring scan signals to a plurality of first scan lines connected to a first group pixel configured by a plurality of pixels or a plurality of second scan lines connected to a second group pixel different from the first group pixel and configured by a plurality of pixels, the method comprising:
generating and outputting a plurality of first signals to the plurality of output lines in sequence or generating and outputting a plurality of second signals at the same time by the signal generator;
receiving a first selection signal selecting the plurality of first scan lines or a second selection signal selecting the plurality of second scan lines by the switching unit; and
outputting the plurality of first signals or the plurality of second signals as the scan signals by selecting the plurality of first scan lines or the plurality of second scan lines according to the first selection signal or the second selection signal.

48. The driving method of a scan driver of claim 47, wherein:
the signal generator includes a first driver connected to the plurality of output lines and a second driver connected to the plurality of output lines, and
outputting the plurality of first signals or the plurality of second signals to the plurality of output lines by the signal generator includes:
scan-enabling by applying the plurality of first signals or the plurality of second signals to the plurality of output lines by any one of the first driver and the second driver, and
floating an output terminal.

49. The driving method of a scan driver of claim 48, wherein:
during scan enabling, another of the first and the second drivers connected to the plurality of output lines is in a state where the output terminal thereof is floated.

50. The driving method of a scan driver of claim 48, wherein:
during floating of the output terminal, another of the first and the second drivers connected to the plurality of output lines is in a scan enable state where the signals is transferred to the plurality of output lines.
